(19) United States
(12) Patent Application Publication
(10) Pub. No.: US 2014/0214336 A1
(43) Pub. Date: Jul. 31, 2014

(54) SYSTEMS AND METHODS FOR NETWORK-BASED BIOLOGICAL ACTIVITY ASSESSMENT

(71) Applicant: Florian Martin, Peseux (CH)

(72) Inventor: Florian Martin, Peseux (CH)

(73) Assignee: PHILIP MORRIS PRODUCTS S.A., Neuchatel (CH)

(21) Appl. No.: 14/342,689

(22) PCT Filed: Sep. 7, 2012
(86) PCT No.: PCT/EP2012/003760

§ 371 Date: Mar. 4, 2014

Related U.S. Application Data
(60) Provisional application No. 61/532,972, filed on Sep. 9, 2011.

(51) Int. Cl. G06F 19/00

(52) U.S. Cl. CPC G06F 19/36
USPC 702/19

(57) ABSTRACT

Systems and methods are disclosed herein for quantifying the response of a biological system to one or more perturbations based on measured activity data from a subset of the entities in the biological system. Based on the activity data and a network model of the biological system that describes the relationships between measured and non-measured entities, activities of entities that are not measured are inferred. The inferred activities are used for deriving a score quantifying the response of the biological system to a perturbation such as a response to a treatment condition. The score may be representative of the magnitude and topological distribution of the response of the network to the perturbation.

### BACKGROUND

The human body is constantly perturbed by exposure to potentially harmful agents that can pose severe health risks in the long-term. Exposure to these agents can compromise the normal functioning of biological mechanisms internal to the human body. To understand and quantify the effect that these perturbations have on the human body, researchers study the mechanism by which biological systems respond to exposure to agents. Some groups have extensively utilized in vivo animal testing methods. However, animal testing methods are not always sufficient because there is doubt as to their reliability and relevance. Numerous differences exist in the physiology of different animals. Therefore, different species may respond differently to exposure to an agent. Accordingly, there is doubt as to whether responses obtained from animal testing may be extrapolated to human biology. Other methods include assessing risk through clinical studies of human volunteers. But these risk assessments are performed a posteriori and, because diseases may take decades to manifest, these assessments may not be sufficient to elucidate mechanisms that link harmful substances to disease. Yet other methods include in vitro experiments. Although, in vitro cell and tissue-based methods have received general acceptance as full or partial replacement methods for their animal-based counterparts, these methods have limited value. Because in vitro methods are focused on specific aspects of cells and tissues mechanisms; they do not always take into account the complex interactions that occur in the overall biological system.

In the last decade, high-throughput measurements of nucleic acid, protein and metabolite levels in conjunction with traditional dose-dependent efficacy and toxicity assays, have emerged as a means for elucidating mechanisms of action of many biological processes. Researchers have attempted to combine information from these disparate measurements with knowledge about biological pathways from the scientific literature to assemble meaningful biological models. To this end, researchers have begun using mathematical and computational techniques that can mine large quantities of data, such as clustering and statistical methods, to identify possible biological mechanisms of action.

Previous work has also explored the importance of uncovering a characteristic signature of gene expression changes that results from one or more perturbations to a biological process, and the subsequent scoring of the presence of that signature in additional data sets as a measure of the specific activity amplitude of that process. Most work in this regard has involved identifying and scoring signatures that are correlated with a disease phenotype. These phenotype-derived signatures provide significant classification power, but lack a mechanistic or causal relationship between a single specific perturbation and the signature. Consequently, these signatures may represent multiple distinct unknown perturbations that, by often unknown mechanism(s), lead to, or result from, the same disease phenotype.

One challenge lies in understanding how the activities of various individual biological entities in a biological system enable the activation or suppression of different biological mechanisms. Because an individual entity, such as a gene, may be involved in multiple biological processes (e.g., inflammation and cell proliferation), measurement of the activity of the gene is not sufficient to identify the underlying biological process that triggers the activity.

### SUMMARY

Described herein are systems and methods for quantifying the response of a biological system to one or more perturbations based on measured activity data from a subset of the entities in the biological system. None of the current techniques has been applied to identify the underlying mechanisms responsible for the activity of biological entities on a micro-scale, nor provide a quantitative assessment of the activation of different biological mechanisms in which these entities play a role, in response to potentially harmful agents and experimental conditions. Accordingly, there is a need for improved systems and methods for analyzing system-wide biological data in view of biological mechanisms, and quantifying changes in the biological system as the system responds to an agent or a change in the environment. Systems and methods are described for inferring the activity of entities that are not measured based on the measured activity data and a network model of the biological system that describes the relationships between measured and non-measured entities.

In one aspect, the systems and methods described herein are directed to computerized methods and one or more computer processors for quantifying the perturbation of a biological system (for example, in response to a treatment condition such as agent exposure, or in response to multiple treatment conditions). The computerized method may include receiving, at a first processor, a first set of treatment data corresponding to a response of a first set of biological entities to a first treatment. The first set of biological entities, and a second set of biological entities, are included in a first biological system. Each biological entity in the first biological system interacts with at least one other of the biological entities in the first biological system. The computerized method may also include receiving, at a second processor, a second set of treatment data corresponding to a response of the first set of biological entities to a second treatment different from the first treatment. In some implementations, the first set of treatment data represents exposure to an agent, and the second set of treatment data is control data. The computerized method may further include providing, at a third processor, a first computational causal network model that represents the first biological system. The first computational model includes a first set of nodes representing the first set of biological entities, a second set of nodes representing the second set of biological entities, edges connecting nodes and representing relationships between the biological entities, and direction values, for the nodes or edges, representing the expected direction of change between the first control data and the first treatment data. In some implementations, the edges and direction values represent causal activation relationships between nodes.

The computerized method may further include calculating, with a fourth processor, a first set of activity measures representing a difference between the first treatment data and the second treatment data for corresponding nodes in the first set of nodes.

The computerized method may further include generating, with a fifth processor, a second set of activity values for corresponding nodes in the second set of nodes, based on the first computational causal network model and the first set of activity measures. In some implementations, generating the second set of activity values comprises selecting, for each particular node in the second set of nodes, an activity value that minimizes a difference statement that represents the difference between the activity value of the particular node and the activity value or activity measure of nodes to which the particular node is connected with an edge within the first computational causal network model, wherein the difference statement depends on the activity values of each node in the second set of nodes. The difference statement may further depend on the direction values of each node in the second set of nodes. In some implementations, each activity value in the second set of activity values is a linear combination of activity measures of the first set of activity measures. In particular, the linear combination may depend on edges between nodes in the first set of nodes and nodes in the second set of nodes within the first computational causal network model, and also depends on edges between nodes in the second set of nodes within the first computational causal network model, and may not depend on edges between nodes in the first set of nodes within the first computational causal network model.

Finally, the computerized method may include generating, with a sixth processor, a score for the first computational model representative of the perturbation of the first biological system to the first agent based on the first computational causal network model and the second set of activity values. In some implementations, the score has a quadratic dependence on the second set of activity values. The computerized method may also include providing a variation estimate for each activity value of the second set of activity values by forming a linear combination of variation estimates for each activity measure of the first set of activity measures. A variation estimate for each activity value of the second set of activity values may be a linear combination of variation estimates for each activity measure of the first set of activity measures, for example. A variation estimate for the score may have a quadratic dependence on the second set of activity values.

In some implementations, the second set of activity values is represented as a first activity value vector and the first activity value vector is decomposed into a first contributing vector and a first non-contributing vector, such that the sum of the first contributing and non-contributing vectors is the first activity value vector. The score may not depend on the first non-contributing vector, and may be calculated as a quadratic function of the second set of activity values. In such an implementation, the first non-contributing vector may be in a kernel of the quadratic function. In some implementations, the first non-contributing vector is in a kernel of a quadratic function based on a signed Laplacian associated with a computational causal network model (such as the first computational causal network model).

The activity measures and activity values described above may be used to provide comparability information that reflects the concordance or discordance between different agents and treatment conditions applied to the same biological system. To do so, the computerized method may also include receiving, at the first processor, a third set of treatment data corresponding to a response of the first set of biological entities to the first treatment; receiving, at the second processor, a fourth set of treatment data corresponding to a response of the first set of biological entities to the second treatment; and calculating, with the fourth processor, a third set of activity measures corresponding to the first set of nodes, each activity measure in the third set of activity measures representing a difference between the third set of treatment data and the fourth set of treatment data for a corresponding node in the first set of nodes. The computerized method may further include generating, with the fifth processor, a fourth set of activity values, each activity value in the fourth set of activity values representing an activity value for a corresponding node in the second set of nodes, the fourth set of activity values based on the computational causal network model and the third set of activity measures; and representing a fourth set of activity values as a second activity value vector.

The computerized method may also include decomposing the second activity value vector into a second contributing vector and a second non-contributing vector, such that the sum of the second contributing and non-contributing vectors is the second activity value vector, and comparing the first and second contributing vectors. In some implementations, comparing the first and second contributing vectors includes calculating a correlation between the first and second contributing vectors to indicate the comparability of the first and third sets of treatment data. In some embodiments, comparing the first and second contributing vectors includes projecting the first and second contributing vectors onto an image space of a signed Laplacian of a computational network model. In some implementations, the second set of treatment data contains the same information as the fourth set of treatment data.

The activity measure and activity values described above may be used to provide translatability information that reflects the degree to which two difference biological system respond analogously to perturbation by the same agent or treatment conditions. To do so, the computerized method may also include receiving, at the first processor, a third set of treatment data corresponding to a response of a third set of biological entities to a third treatment different from the first treatment, wherein a second biological system comprises a plurality of biological entities including the third set of biological entities and a fourth set of biological entities, each biological entity in the second biological system interacting with at least one other of the biological entities in the second biological system. The computerized method may further include receiving, at the second processor, a fourth set of treatment data corresponding to a response of the third set of biological entities to a fourth treatment different from the third treatment. Additionally, the computerized method may include providing, at the third processor, a second computational causal network model that represents the second biological system. The second computational causal network model includes a third set of nodes representing the third set of biological entities, a fourth set of nodes representing the fourth set of biological entities, edges connecting nodes and representing relationships between the biological entities, and direction values, for the nodes, representing the expected direction of change between the second control data and the second treatment data.

The computerized method may further include calculating, with the fourth processor, a third set of activity measures corresponding to the third set of nodes, each activity measure in the third set of activity measures representing a difference between the third set of treatment data and the fourth set of treatment data for a corresponding node in the third set of nodes, and generating, with the fifth processor, a fourth set of activity values, each activity value in the fourth set of activity values for corresponding nodes in the fourth set of nodes, based on the second computational causal network model and the third set of activity measures. Finally, the computerized method may include comparing the fourth set of activity values to the second set of activity values. In some implementations, comparing the fourth set of activity values to the second set of activity values includes applying a kernel canonical correlation analysis based on a signed Laplacian associated with the first computational causal network model and a signed Laplacian associated with the second computational causal network model.

In certain implementations, each of the first through sixth processors is included within a single processor or single computing device. In other implementations, one or more of the first through sixth processors are distributed across a plurality of processors or computing devices.

In certain implementations, the computational causal network model includes a set of causal relationships that exist between a node representing a potential cause and nodes representing the measured quantities. In such implementations, the activity measures may include a fold-change. The fold-change may be a number describing how much a node measurement changes going from an initial value to a final value between control data and treatment data, or between two sets of data representing different treatment conditions. The fold-change number may represent the logarithm of the fold-change of the activity of the biological entity between the two conditions. The activity measure for each node may include a logarithm of the difference between the treatment data and the control data for the biological entity represented by the respective node. In certain implementations, the computerized method includes generating, with a processor, a confidence interval for each of the generated scores.

In certain implementations, the subset of the biological system includes, but is not limited to, at least one of a cell proliferation mechanism, a cellular stress mechanism, a cell inflammation mechanism, and a DNA repair mechanism. The agent may include, but is not limited to, a heterogeneous substance, including a molecule or an entity that is not present in or derived from the biological system. The agent may also include, but is not limited to, toxins, therapeutic compounds, stimulants, relaxants, natural products, manufactured products, and food substances. The agent may include, but is not limited to, at least one of aerosol generated by heating tobacco, aerosol generated by combusting tobacco, tobacco smoke, and cigarette smoke. The agent may include, but is not limited to, cadmium, mercury, chromium, nicotine, tobacco-specific nitrosamines and their metabolites (4-(methylnitrosamino)-1-(3-pyridyl)-1-butanone (NNK), N′-nitrosonornicotine (NNN), N-nitrosoanatabine (NAT), N-nitrosoanabasine (NAB), and 4-(methylnitrosamino)-1-(3-pyridyl)-1-butanol (NNAL)). In certain implementations, the agent includes a product used for nicotine replacement therapy.

The computerized methods described herein may be implemented in a computerized system having one or more computing devices, each including one or more processors. Generally, the computerized systems described herein may comprise one or more engines, which include a processing device or devices, such as a computer, microprocessor, logic device or other device or processor that is configured with hardware, firmware, and software to carry out one or more of the computerized methods described herein. In certain implementations, the computerized system includes a systems response profile engine, a network modeling engine, and a network scoring engine. The engines may be interconnected from time to time, and further connected from time to time to one or more databases, including a perturbations database, a measurables database, an experimental data database and a literature database. The computerized system described herein may include a distributed computerized system having one or more processors and engines that communicate through a network interface. Such an implementation may be appropriate for distributed computing over multiple communication systems.

### BRIEF DESCRIPTION OF THE DRAWINGS

Further features of the disclosure, its nature and various advantages, will be apparent upon consideration of the following detailed description, taken in conjunction with the accompanying drawings, in which like reference characters refer to like parts throughout, and in which:

FIG. 1 is a block diagram of an illustrative computerized system for quantifying the response of a biological network to a perturbation.

FIG. 2 is a flow diagram of an illustrative process for quantifying the response of a biological network to a perturbation by calculating a network perturbation amplitude (NPA) score.

FIG. 3 is a graphical representation of data underlying a systems response profile comprising data for two agents, two parameters, and N biological entities.

FIG. 4 is an illustration of a computational model of a biological network having several biological entities and their relationships.

FIG. 5 is a flow diagram of an illustrative process for quantifying the perturbation of a biological system.

FIG. 6 is a flow diagram of an illustrative process for generating activity values for a set of nodes.

FIG. 7 is a flow diagram of an illustrative process for providing comparability information.

FIG. 8 is a flow diagram of an illustrative process for providing translatability information.

FIG. 9 is a flow diagram of an illustrative process for calculating confidence intervals for activity values and NPA scores.

FIG. 10 illustrates a causal biological network model with backbone nodes and supporting nodes.

FIGS. 11-12 are flow diagrams of illustrative processes for determining a statistical significance of an NPA score.

FIG. 13 is a flow diagram of an illustrative process for identifying leading backbone and gene nodes.

FIG. 14 is a block diagram of an exemplary distributed computerized system for quantifying the impact of biological perturbations.

FIG. 15 is a block diagram of an exemplary computing device which may be used to implement any of the components in any of the computerized systems described herein.

FIG. 16 illustrates example results from two experiments with similar (top) and dissimilar biology (bottom).

FIGS. 17-18 illustrate example results from a cell culture experiment for quantifying the perturbation of a biological system

### DETAILED DESCRIPTION

Described herein are computational systems and methods that assess quantitatively the magnitude of changes within a biological system when it is perturbed by an agent. Certain implementations include methods for computing a numerical value that expresses the magnitude of changes within a portion of a biological system. The computation uses as input, a set of data obtained from a set of controlled experiments in which the biological system is perturbed by an agent. The data is then applied to a network model of a feature of the biological system. The network model is used as a substrate for simulation and analysis, and is representative of the biological mechanisms and pathways that enable a feature of interest in the biological system. The feature or some of its mechanisms and pathways may contribute to the pathology of diseases and adverse effects of the biological system. Prior knowledge of the biological system represented in a database is used to construct the network model which is populated by data on the status of numerous biological entities under various conditions including under normal conditions and under perturbation by an agent. The network model used is dynamic in that it represents changes in status of various biological entities in response to a perturbation and can yield quantitative and objective assessments of the impact of an agent on the biological system. Computer systems for operating these computational methods are also provided.

The numerical values generated by computerized methods of the disclosure can be used to determine the magnitude of desirable or adverse biological effects caused by manufactured products (for safety assessment or comparisons), therapeutic compounds including nutrition supplements (for determination of efficacy or health benefits), and environmentally active substances (for prediction of risks of long term exposure and the relationship to adverse effect and onset of disease), among others.

In one aspect, the systems and methods described herein provide a computed numerical value representative of the magnitude of change in a perturbed biological system based on a network model of a perturbed biological mechanism. The numerical value referred to herein as a network perturbation amplitude (NPA) score can be used to summarily represent the status changes of various entities in a defined biological mechanism. The numerical values obtained for different agents or different types of perturbations can be used to compare relatively the impact of the different agents or perturbations on a biological mechanism which enables or manifests itself as a feature of a biological system. Thus, NPA scores may be used to measure the responses of a biological mechanism to different perturbations. The term “score” is used herein generally to refer to a value or set of values which provide a quantitative measure of the magnitude of changes in a biological system. Such a score is computed by using any of various mathematical and computational algorithms known in the art and according to the methods disclosed herein, employing one or more datasets obtained from a sample or a subject.

The NPA scores may assist researchers and clinicians in improving diagnosis, experimental design, therapeutic decision, and risk assessment. For example, the NPA scores may be used to screen a set of candidate biological mechanisms in a toxicology analysis to identify those most likely to be affected by exposure to a potentially harmful agent. By providing a measure of network response to a perturbation, these NPA scores may allow correlation of molecular events (as measured by experimental data) with phenotypes or biological outcomes that occur at the cell, tissue, organ or organism level. A clinician may use NPA values to compare the biological mechanisms affected by an agent to a patient's physiological condition to determine what health risks or benefits the patient is most likely to experience when exposed to the agent (e.g., a patient who is immuno-compromised may be especially vulnerable to agents that cause a strong immuno-suppressive response).

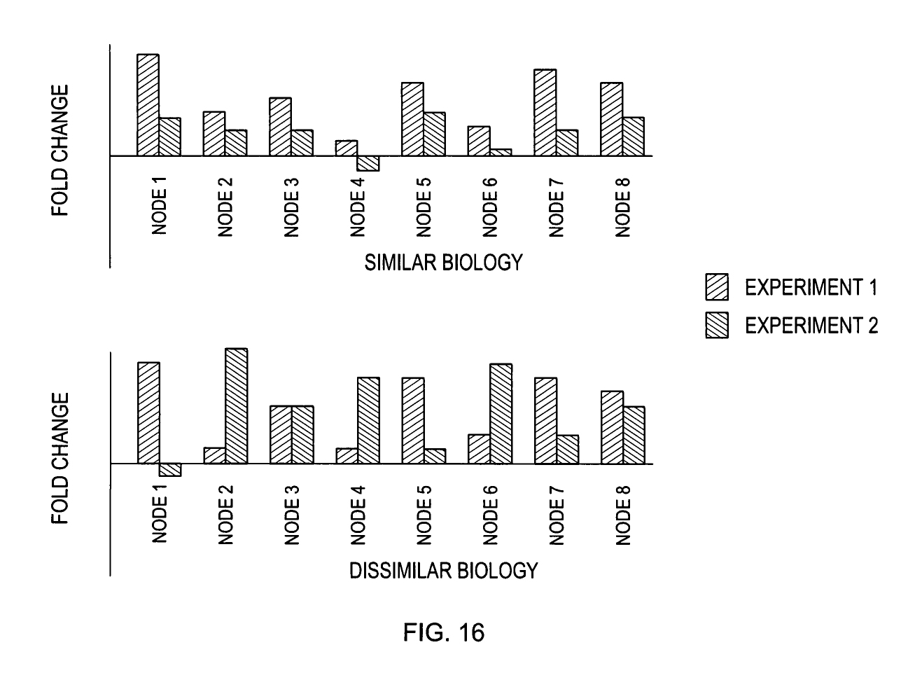

Also described herein are systems and methods for quantifying experimental data and network models of biological mechanisms to enable comparisons between different experiments on the same biological network, referred to herein as “comparability.” In some implementations, comparability is quantified by statistical metrics that compare NPA or other perturbation quantifications across experimental datasets. Comparability metrics may help identify, for example, whether the effects on the activation of a particular biological network (such as NFKB) by two stimuli (such as TNF and IL1a) were supported by the same underlying biology. FIG. 16 illustrates example results from two experiments with similar (top) and dissimilar biology (bottom). In the results on the top, Experiment 1 leads to about twice the response of the experimental system compared to Experiment 2 across all measured nodes, indicating that the Experiment 2 induces the same underlying biology as Experiment 1, albeit to a lesser extent. In the results on the bottom, there is no correlation between the experimental system response of each measurement between Experiment 1 and Experiment 2, suggesting that (despite the fact that both experiments elicit the same average experimental response) the biology induced by the two experiments is not comparable. The comparability measures described herein may be used to identify similar or dissimilar biology within a network when comparing different exposures, or the same exposures across different doses. Such measures may point the biologist to the areas of the network requiring more in-depth analysis for proper understanding of the experimental results or other quantifications of the biological response, such as an NPA score.

Also described herein are systems and methods for quantifying experimental data and network models of biological mechanisms to enable comparisons between analogous biological networks between species, systems or mechanisms, referred to herein as “translatability.” Translatability measures provide an indication of the applicability of experimental perturbation data and scores (such as NPA scores) between such species, systems or mechanisms. For example, the translatability measures described herein may be used to compare in vivo experiments to in vitro experiments, mouse experiments to human experiments, rat experiments to human experiments, mouse experiments to rat experiments, non-human primate experiments to human experiments, and other comparable species, systems or mechanisms exposed to different treatments (such as exposure to agents).

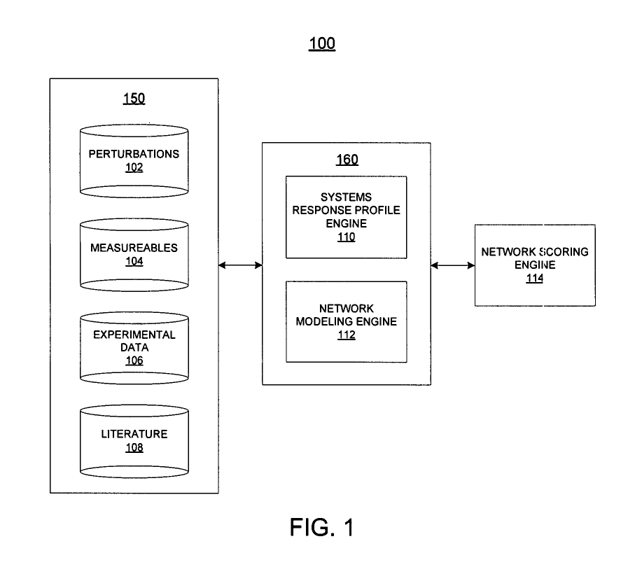

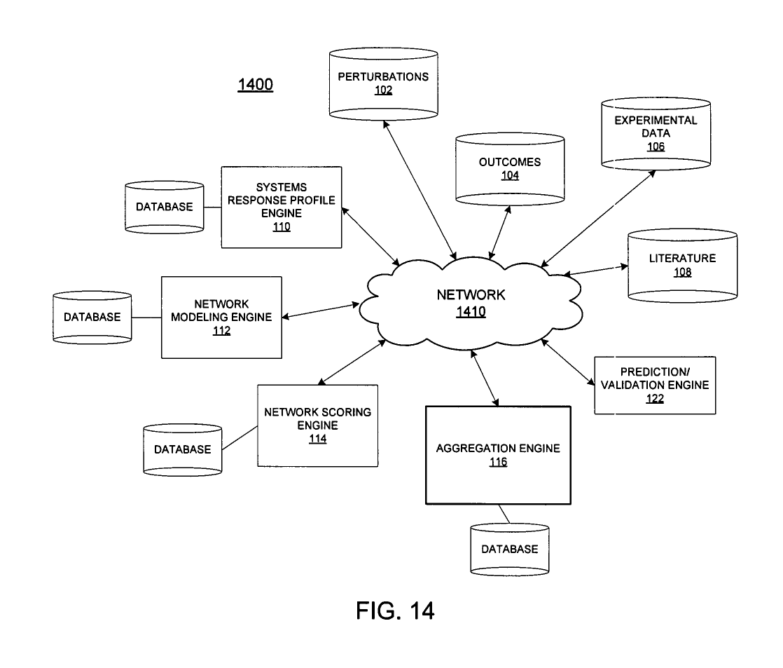

FIG. 1 is a block diagram of a computerized system 100 for quantifying the response of a network model to a perturbation. In particular, system 100 includes a systems response profile engine 110, a network modeling engine 112, and a network scoring engine 114. The engines 110, 112, and 114 are interconnected from time to time, and further connected from time to time to one or more databases, including a perturbations database 102, a measurables database 104, an experimental data database 106 and a literature database 108. As used herein, an engine includes a processing device or devices, such as a computer, microprocessor, logic device or other device or devices as described with reference to FIG. 14, that is configured with hardware, firmware, and software to carry out one or more computational operations.

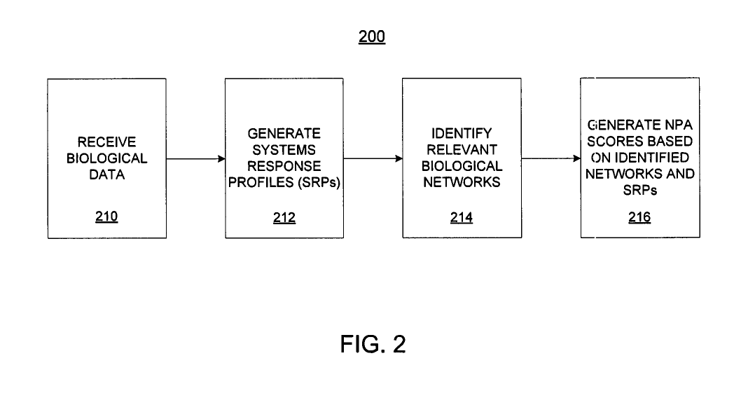

FIG. 2 is a flow diagram of a process 200 for quantifying the response of a biological network to a perturbation by calculating a network perturbation amplitude (NPA) score, according to one implementation. The steps of the process 200 will be described as being carried out by various components of the system 100 of FIG. 1, but any of these steps may be performed by any suitable hardware or software components, local or remote, and may be arranged in any appropriate order or performed in parallel. At step 210, the systems response profile (SRP) engine 110 receives biological data from a variety of different sources, and the data itself may be of a variety of different types. The data includes data from experiments in which a biological system is perturbed, as well as control data. At step 212, the SRP engine 110 generates systems response profiles (SRPs) which are representations of the degree to which one or more entities within a biological system change in response to the presentation of an agent to the biological system. At step 214, the network modeling engine 112 provides one or more databases that contain(s) a plurality of network models, one of which is selected as being relevant to the agent or a feature of interest. The selection can be made on the basis of prior knowledge of the mechanisms underlying the biological functions of the system. In certain implementations, the network modeling engine 112 may extract causal relationships between entities within the system using the systems response profiles, networks in the database, and networks previously described in the literature, thereby generating, refining or extending a network model. At step 216, the network scoring engine 114 generates NPA scores for each perturbation using the network identified at step 214 by the network modeling engine 112 and the SRPs generated at step 212 by the SRP engine 110. An NPA score quantifies a biological response to a perturbation or treatment (represented by the SRPs) in the context of the underlying relationships between the biological entities (represented by the network). The following description is divided into subsections for clarity of disclosure, and not by way of limitation.

A biological system in the context of the present disclosure is an organism or a part of an organism, including functional parts, the organism being referred to herein as a subject. The subject is generally a mammal, including a human. The subject can be an individual human being in a human population. The term “mammal” as used herein includes but is not limited to a human, non-human primate, mouse, rat, dog, cat, cow, sheep, horse, and pig. Mammals other than humans can be advantageously used as subjects that can be used to provide a model of a human disease. The non-human subject can be unmodified, or a genetically modified animal (e.g., a transgenic animal, or an animal carrying one or more genetic mutation(s), or silenced gene(s)). A subject can be male or female. Depending on the objective of the operation, a subject can be one that has been exposed to an agent of interest. A subject can be one that has been exposed to an agent over an extended period of time, optionally including time prior to the study. A subject can be one that had been exposed to an agent for a period of time but is no longer in contact with the agent. A subject can be one that has been diagnosed or identified as having a disease. A subject can be one that has already undergone, or is undergoing treatment of a disease or adverse health condition. A subject can also be one that exhibits one or more symptoms or risk factors for a specific health condition or disease. A subject can be one that is predisposed to a disease, and may be either symptomatic or asymptomatic. In certain implementations, the disease or health condition in question is associated with exposure to an agent or use of an agent over an extended period of time. According to some implementations, the system 100 (FIG. 1) contains or generates computerized models of one or more biological systems and mechanisms of its functions (collectively, “biological networks” or “network models”) that are relevant to a type of perturbation or an outcome of interest.

Depending on the context of the operation, the biological system can be defined at different levels as it relates to the function of an individual organism in a population, an organism generally, an organ, a tissue, a cell type, an organelle, a cellular component, or a specific individual's cell(s). Each biological system comprises one or more biological mechanisms or pathways, the operation of which manifest as functional features of the system. Animal systems that reproduce defined features of a human health condition and that are suitable for exposure to an agent of interest are preferred biological systems. Cellular and organotypical systems that reflect the cell types and tissue involved in a disease etiology or pathology are also preferred biological systems. Priority could be given to primary cells or organ cultures that recapitulate as much as possible the human biology in vivo. It is also important to match the human cell culture in vitro with the most equivalent culture derived from the animal models in vivo. This enables creation of a translational continuum from animal model to human biology in vivo using the matched systems in vitro as reference systems. Accordingly, the biological system contemplated for use with the systems and methods described herein can be defined by, without limitation, functional features (biological functions, physiological functions, or cellular functions), organelle, cell type, tissue type, organ, development stage, or a combination of the foregoing. Examples of biological systems include, but are not limited to, the pulmonary, integument, skeletal, muscular, nervous (central and peripheral), endocrine, cardiovascular, immune, circulatory, respiratory, urinary, renal, gastrointestinal, colorectal, hepatic and reproductive systems. Other examples of biological systems include, but are not limited to, the various cellular functions in epithelial cells, nerve cells, blood cells, connective tissue cells, smooth muscle cells, skeletal muscle cells, fat cells, ovum cells, sperm cells, stem cells, lung cells, brain cells, cardiac cells, laryngeal cells, pharyngeal cells, esophageal cells, stomach cells, kidney cells, liver cells, breast cells, prostate cells, pancreatic cells, islet cells, testes cells, bladder cells, cervical cells, uterus cells, colon cells, and rectum cells. Some of the cells may be cells of cell lines, cultured in vitro or maintained in vitro indefinitely under appropriate culture conditions. Examples of cellular functions include, but are not limited to, cell proliferation (e.g., cell division), degeneration, regeneration, senescence, control of cellular activity by the nucleus, cell-to-cell signaling, cell differentiation, cell de-differentiation, secretion, migration, phagocytosis, repair, apoptosis, and developmental programming. Examples of cellular components that can be considered as biological systems include, but are not limited to, the cytoplasm, cytoskeleton, membrane, ribosomes, mitochondria, nucleus, endoplasmic reticulum (ER), Golgi apparatus, lysosomes, DNA, RNA, proteins, peptides, and antibodies.

A perturbation in a biological system can be caused by one or more agents over a period of time through exposure or contact with one or more parts of the biological system. An agent can be a single substance or a mixture of substances, including a mixture in which not all constituents are identified or characterized. The chemical and physical properties of an agent or its constituents may not be fully characterized. An agent can be defined by its structure, its constituents, or a source that under certain conditions produces the agent. An example of an agent is a heterogeneous substance, that is a molecule or an entity that is not present in or derived from the biological system, and any intermediates or metabolites produced therefrom after contacting the biological system. An agent can be a carbohydrate, protein, lipid, nucleic acid, alkaloid, vitamin, metal, heavy metal, mineral, oxygen, ion, enzyme, hormone, neurotransmitter, inorganic chemical compound, organic chemical compound, environmental agent, microorganism, particle, environmental condition, environmental force, or physical force. Non-limiting examples of agents include but are not limited to nutrients, metabolic wastes, poisons, narcotics, toxins, therapeutic compounds, stimulants, relaxants, natural products, manufactured products, food substances, pathogens (prion, virus, bacteria, fungi, protozoa), particles or entities whose dimensions are in or below the micrometer range, by-products of the foregoing and mixtures of the foregoing. Non-limiting examples of a physical agent include radiation, electromagnetic waves (including sunlight), increase or decrease in temperature, shear force, fluid pressure, electrical discharge(s) or a sequence thereof, or trauma.

Some agents may not perturb a biological system unless it is present at a threshold concentration or it is in contact with the biological system for a period of time, or a combination of both. Exposure or contact of an agent resulting in a perturbation may be quantified in terms of dosage. Thus, perturbation can result from a long-term exposure to an agent. The period of exposure can be expressed by units of time, by frequency of exposure, or by the percentage of time within the actual or estimated life span of the subject. A perturbation can also be caused by withholding an agent (as described above) from or limiting supply of an agent to one or more parts of a biological system. For example, a perturbation can be caused by a decreased supply of or a lack of nutrients, water, carbohydrates, proteins, lipids, alkaloids, vitamins, minerals, oxygen, ions, an enzyme, a hormone, a neurotransmitter, an antibody, a cytokine, light, or by restricting movement of certain parts of an organism, or by constraining or requiring exercise.

An agent may cause different perturbations depending on which part(s) of the biological system is exposed and the exposure conditions. Non-limiting examples of an agent may include aerosol generated by heating tobacco, aerosol generated by combusting tobacco, tobacco smoke, cigarette smoke, and any of the gaseous constituents or particulate constituents thereof. Further non-limiting examples of an agent include cadmium, mercury, chromium, nicotine, tobacco-specific nitrosamines and their metabolites (4-(methylnitrosamino)-1-(3-pyridyl)-1-butanone (NNK), N′-nitrosonornicotine (NNN), N-nitrosoanatabine (NAT), N-nitrosoanabasine (NAB), 4-(methylnitrosamino)-1-(3-pyridyl)-1-butanol (NNAL)), and any product used for nicotine replacement therapy. An exposure regimen for an agent or complex stimulus should reflect the range and circumstances of exposure in everyday settings. A set of standard exposure regimens can be designed to be applied systematically to equally well-defined experimental systems. Each assay could be designed to collect time and dose-dependent data to capture both early and late events and ensure a representative dose range is covered. However, it will be understood by one of ordinary skill in the art that the systems and methods described herein may be adapted and modified as is appropriate for the application being addressed and that the systems and methods designed herein may be employed in other suitable applications, and that such other additions and modifications will not depart from the scope thereof.

In various implementations, high-throughput system-wide measurements for gene expression, protein expression or turnover, microRNA expression or turnover, post-translational modifications, protein modifications, translocations, antibody production metabolite profiles, or a combination of two or more of the foregoing are generated under various conditions including the respective controls. Functional outcome measurements are desirable in the methods described herein as they can generally serve as anchors for the assessment and represent clear steps in a disease etiology.

A “sample” as used herein refers to any biological sample that is isolated from a subject or an experimental system (e.g., cell, tissue, organ, or whole animal). A sample can include, without limitation, a single cell or multiple cells, cellular fraction, tissue biopsy, resected tissue, tissue extract, tissue, tissue culture extract, tissue culture medium, exhaled gases, whole blood, platelets, serum, plasma, erythrocytes, leucocytes, lymphocytes, neutrophils, macrophages, B cells or a subset thereof, T cells or a subset thereof, a subset of hematopoietic cells, endothelial cells, synovial fluid, lymphatic fluid, ascites fluid, interstitial fluid, bone marrow, cerebrospinal fluid, pleural effusions, tumor infiltrates, saliva, mucous, sputum, semen, sweat, urine, or any other bodily fluids. Samples can be obtained from a subject by means including but not limited to venipuncture, excretion, biopsy, needle aspirate, lavage, scraping, surgical resection, or other means known in the art.

During operation, for a given biological mechanism, an outcome, a perturbation, or a combination of the foregoing, the system 100 can generate a network perturbation amplitude (NPA) value, which is a quantitative measure of changes in the status of biological entities in a network in response to a treatment condition.

The system 100 (FIG. 1) comprises one or more computerized network model(s) that are relevant to the health condition, disease, or biological outcome, of interest. One or more of these network models are based on prior biological knowledge and can be uploaded from an external source and curated within the system 100. The models can also be generated de novo within the system 100 based on measurements. Measurable elements are causally integrated into biological network models through the use of prior knowledge. Described below are the types of data that represent changes in a biological system of interest that can be used to generate or refine a network model, or that represent a response to a perturbation.

Referring to FIG. 2, at step 210, the systems response profile (SRP) engine 110 receives biological data. The SRP engine 110 may receive this data from a variety of different sources, and the data itself may be of a variety of different types. The biological data used by the SRP engine 110 may be drawn from the literature, databases (including data from preclinical, clinical and post-clinical trials of pharmaceutical products or medical devices), genome databases (genomic sequences and expression data, e.g., Gene Expression Omnibus by National Center for Biotechnology Information or ArrayExpress by European Bioinformatics Institute (Parkinson et al. 2010, Nucl. Acids Res., doi: 10.1093/nar/gkq1040. Pubmed ID 21071405)), commercially available databases (e.g., Gene Logic, Gaithersburg, Md., USA) or experimental work. The data may include raw data from one or more different sources, such as in vitro, ex vivo or in vivo experiments using one or more species that are specifically designed for studying the effect of particular treatment conditions or exposure to particular agents. In vitro experimental systems may include tissue cultures or organotypical cultures (three-dimensional cultures) that represent key aspects of human disease. In such implementations, the agent dosage and exposure regimens for these experiments may substantially reflect the range and circumstances of exposures that may be anticipated for humans during normal use or activity conditions, or during special use or activity conditions. Experimental parameters and test conditions may be selected as desired to reflect the nature of the agent and the exposure conditions, molecules and pathways of the biological system in question, cell types and tissues involved, the outcome of interest, and aspects of disease etiology. Particular animal-model-derived molecules, cells or tissues may be matched with particular human molecule, cell or tissue cultures to improve translatability of animal-based findings.

The data received by SRP engine 110 many of which are generated by high-throughput experimental techniques, include but are not limited to that relating to nucleic acid (e.g., absolute or relative quantities of specific DNA or RNA species, changes in DNA sequence, RNA sequence, changes in tertiary structure, or methylation pattern as determined by sequencing, hybridization—particularly to nucleic acids on microarray, quantitative polymerase chain reaction, or other techniques known in the art), protein/peptide (e.g., absolute or relative quantities of protein, specific fragments of a protein, peptides, changes in secondary or tertiary structure, or posttranslational modifications as determined by methods known in the art) and functional activities (e.g., enzymatic activities, proteolytic activities, transcriptional regulatory activities, transport activities, binding affinities to certain binding partners) under certain conditions, among others. Modifications including posttranslational modifications of protein or peptide can include, but are not limited to, methylation, acetylation, farnesylation, biotinylation, stearoylation, formylation, myristoylation, palmitoylation, geranylgeranylation, pegylation, phosphorylation, sulphation, glycosylation, sugar modification, lipidation, lipid modification, ubiquitination, sumolation, disulphide bonding, cysteinylation, oxidation, glutathionylation, carboxylation, glucuronidation, and deamidation. In addition, a protein can be modified posttranslationally by a series of reactions such as Amadori reactions, Schiff base reactions, and Maillard reactions resulting in glycated protein products.

The data may also include measured functional outcomes, such as but not limited to those at a cellular level including cell proliferation, developmental fate, and cell death, at a physiological level, lung capacity, blood pressure, exercise proficiency. The data may also include a measure of disease activity or severity, such as but not limited to tumor metastasis, tumor remission, loss of a function, and life expectancy at a certain stage of disease. Disease activity can be measured by a clinical assessment the result of which is a value, or a set of values that can be obtained from evaluation of a sample (or population of samples) from a subject or subjects under defined conditions. A clinical assessment can also be based on the responses provided by a subject to an interview or a questionnaire.

This data may have been generated expressly for use in determining a systems response profile, or may have been produced in previous experiments or published in the literature. Generally, the data includes information relating to a molecule, biological structure, physiological condition, genetic trait, or phenotype. In some implementations, the data includes a description of the condition, location, amount, activity, or substructure of a molecule, biological structure, physiological condition, genetic trait, or phenotype. As will be described later, in a clinical setting, the data may include raw or processed data obtained from assays performed on samples obtained from human subjects or observations on the human subjects, exposed to an agent.

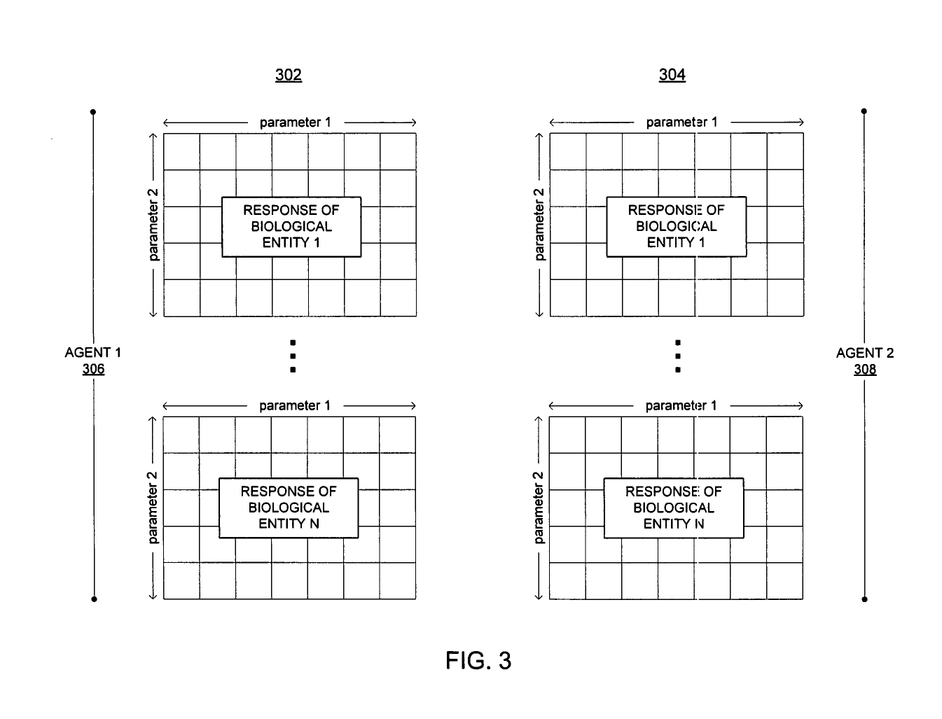

At step 212, the systems response profile (SRP) engine 110 generates systems response profiles (SRPs) based on the biological data received at step 212. This step may include one or more of background correction, normalization, fold-change calculation, significance determination and identification of a differential response (e.g., differentially expressed genes). SRPs are representations that express the degree to which one or more measured entities within a biological system (e.g., a molecule, a nucleic acid, a peptide, a protein, a cell, etc.) are individually changed in response to a perturbation applied to the biological system (e.g., an exposure to an agent). In one example, to generate an SRP, the SRP engine 110 collects a set of measurements for a given set of parameters (e.g., treatment or perturbation conditions) applied to a given experimental system (a “system-treatment” pair). FIG. 3 illustrates two SRPs: SRP 302 that includes biological activity data for N different biological entities undergoing a first treatment 306 with varying parameters (e.g., dose and time of exposure to a first treatment agent), and an analogous SRP 304 that includes biological activity data for the N different biological entities undergoing a second treatment 308. The data included in an SRP may be raw experimental data, processed experimental data (e.g., filtered to remove outliers, marked with confidence estimates, averaged over a number of trials), data generated by a computational biological model, or data taken from the scientific literature. An SRP may represent data in any number of ways, such as an absolute value, an absolute change, a fold-change, a logarithmic change, a function, and a table. The SRP engine 110 passes the SRPs to the network modeling engine 112.

While the SRPs derived in the previous step represent the experimental data from which the magnitude of network perturbation will be determined, it is the biological network models that are the substrate for computation and analysis. This analysis requires development of a detailed network model of the mechanisms and pathways relevant to a feature of the biological system. Such a framework provides a layer of mechanistic understanding beyond examination of gene lists that have been used in more classical gene expression analysis. A network model of a biological system is a mathematical construct that is representative of a dynamic biological system and that is built by assembling quantitative information about various basic properties of the biological system.

Construction of such a network is an iterative process. Delineation of boundaries of the network is guided by literature investigation of mechanisms and pathways relevant to the process of interest (e.g., cell proliferation in the lung). Causal relationships describing these pathways are extracted from prior knowledge to nucleate a network. The literature-based network can be verified using high-throughput data sets that contain the relevant phenotypic endpoints. SRP engine 110 can be used to analyze the data sets, the results of which can be used to confirm, refine, or generate network models.

Returning to FIG. 2, at step 214, the network modeling engine 112 uses the systems response profiles from the SRP engine 110 with a network model based on the mechanism(s) or pathway(s) underlying a feature of a biological system of interest. In certain aspects, the network modeling engine 112 is used to identify networks already generated based on SRPs. The network modeling engine 112 may include components for receiving updates and changes to models. The network modeling engine 112 may also iterate the process of network generation, incorporating new data and generating additional or refined network models. The network modeling engine 112 may also facilitate the merging of one or more datasets or the merging of one or more networks. The set of networks drawn from a database may be manually supplemented by additional nodes, edges, or entirely new networks (e.g., by mining the text of literature for description of additional genes directly regulated by a particular biological entity). These networks contain features that may enable process scoring. Network topology is maintained; networks of causal relationships can be traced from any point in the network to a measurable entity. Further, the models are dynamic and the assumptions used to build them can be modified or restated and enable adaptability to different tissue contexts and species. This allows for iterative testing and improvement as new knowledge becomes available. The network modeling engine 112 may remove nodes or edges that have low confidence or which are the subject of conflicting experimental results in the scientific literature. The network modeling engine 112 may also include additional nodes or edges that may be inferred using supervised or unsupervised learning methods (e.g., metric learning, matrix completion, pattern recognition).

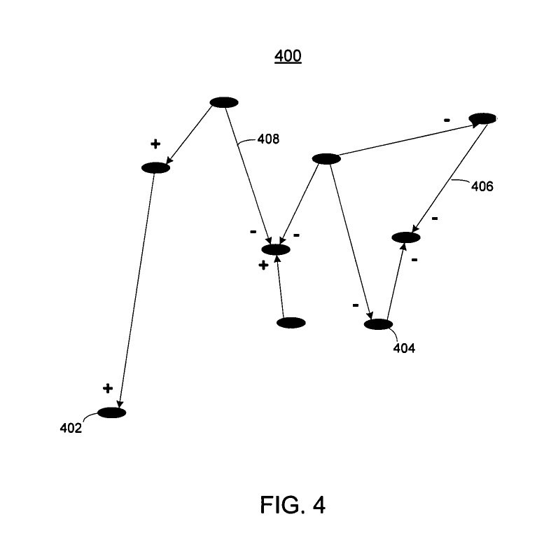

In certain aspects, a biological system is modeled as a mathematical graph consisting of vertices (or nodes) and edges that connect the nodes. For example, FIG. 4 illustrates a simple network 400 with 9 nodes (including nodes 402 and 404) and edges (406 and 408). The nodes can represent biological entities within a biological system, such as, but not limited to, compounds, DNA, RNA, proteins, peptides, antibodies, cells, tissues, and organs. The edges can represent relationships between the nodes. The edges in the graph can represent various relations between the nodes. For example, edges may represent a “binds to” relation, an “is expressed in” relation, an “are co-regulated based on expression profiling” relation, an “inhibits” relation, a “co-occur in a manuscript” relation, or “share structural element” relation. Generally, these types of relationships describe a relationship between a pair of nodes. The nodes in the graph can also represent relationships between nodes. Thus, it is possible to represent relationships between relationships, or relationships between a relationship and another type of biological entity represented in the graph. For example a relationship between two nodes that represent chemicals may represent a reaction. This reaction may be a node in a relationship between the reaction and a chemical that inhibits the reaction.

A graph may be undirected, meaning that there is no distinction between the two vertices associated with each edge. Alternatively, the edges of a graph may be directed from one vertex to another. For example, in a biological context, transcriptional regulatory networks and metabolic networks may be modeled as a directed graph. In a graph model of a transcriptional regulatory network, nodes would represent genes with edges denoting the transcriptional relationships between them. As another example, protein-protein interaction networks describe direct physical interactions between the proteins in an organism's proteome and there is often no direction associated with the interactions in such networks. Thus, these networks may be modeled as undirected graphs. Certain networks may have both directed and undirected edges. The entities and relationships (i.e., the nodes and edges) that make up a graph, may be stored as a web of interrelated nodes in a database in system 100.

The knowledge represented within the database may be of various different types, drawn from various different sources. For example, certain data may represent a genomic database, including information on genes, and relations between them. In such an example, a node may represent an oncogene, while another node connected to the oncogene node may represent a gene that inhibits the oncogene. The data may represent proteins, and relations between them, diseases and their interrelations, and various disease states. There are many different types of data that can be combined in a graphical representation. The computational models may represent a web of relations between nodes representing knowledge in, e.g., a DNA dataset, an RNA dataset, a protein dataset, an antibody dataset, a cell dataset, a tissue dataset, an organ dataset, a medical dataset, an epidemiology dataset, a chemistry dataset, a toxicology dataset, a patient dataset, and a population dataset. As used herein, a dataset is a collection of numerical values resulting from evaluation of a sample (or a group of samples) under defined conditions. Datasets can be obtained, for example, by experimentally measuring quantifiable entities of the sample; or alternatively, or from a service provider such as a laboratory, a clinical research organization, or from a public or proprietary database. Datasets may contain data and biological entities represented by nodes, and the nodes in each of the datasets may be related to other nodes in the same dataset, or in other datasets. Moreover, the network modeling engine 112 may generate computational models that represent genetic information, in, e.g., DNA, RNA, protein or antibody dataset, to medical information, in medical dataset, to information on individual patients in patient dataset, and on entire populations, in epidemiology dataset. In addition to the various datasets described above, there may be many other datasets, or types of biological information that may be included when generating a computation model. For example, a database could further include medical record data, structure/activity relationship data, information on infectious pathology, information on clinical trials, exposure pattern data, data relating to the history of use of a product, and any other type of life science-related information.

The network modeling engine 112 may generate one or more network models representing, for example, the regulatory interaction between genes, interaction between proteins or complex bio-chemical interactions within a cell or tissue. The networks generated by the network modeling engine 112 may include static and dynamic models. The network modeling engine 112 may employ any applicable mathematical schemes to represent the system, such as hyper-graphs and weighted bipartite graphs, in which two types of nodes are used to represent reactions and compounds. The network modeling engine 112 may also use other inference techniques to generate network models, such as an analysis based on over-representation of functionally-related genes within the differentially expressed genes, Bayesian network analysis, a graphical Gaussian model technique or a gene relevance network technique, to identify a relevant biological network based on a set of experimental data (e.g., gene expression, metabolite concentrations, cell response, etc.).

As described above, the network model is based on mechanisms and pathways that underlie the functional features of a biological system. The network modeling engine 112 may generate or contain a model representative of an outcome regarding a feature of the biological system that is relevant to the study of the long-term health risks or health benefits of agents. Accordingly, the network modeling engine 112 may generate or contain a network model for various mechanisms of cellular function, particularly those that relate or contribute to a feature of interest in the biological system, including but not limited to cellular proliferation, cellular stress, cellular regeneration, apoptosis, DNA damage/repair or inflammatory response. In other embodiments, the network modeling engine 112 may contain or generate computational models that are relevant to acute systemic toxicity, carcinogenicity, dermal penetration, cardiovascular disease, pulmonary disease, ecotoxicity, eye irrigation/corrosion, genotoxicity, immunotoxicity, neurotoxicity, pharmacokinetics, drug metabolism, organ toxicity, reproductive and developmental toxicity, skin irritation/corrosion or skin sensitization. Generally, the network modeling engine 112 may contain or generate computational models for status of nucleic acids (DNA, RNA, SNP, siRNA, miRNA, RNAi), proteins, peptides, antibodies, cells, tissues, organs, and any other biological entity, and their respective interactions. In one example, computational network models can be used to represent the status of the immune system and the functioning of various types of white blood cells during an immune response or an inflammatory reaction. In other examples, computational network models could be used to represent the performance of the cardiovascular system and the functioning and metabolism of endothelial cells.

In some implementations of the present disclosure, the network is drawn from a database of causal biological knowledge. This database may be generated by performing experimental studies of different biological mechanisms to extract relationships between mechanisms (e.g., activation or inhibition relationships), some of which may be causal relationships, and may be combined with a commercially-available database such as the Genstruct Technology Platform or the Selventa Knowledgebase, curated by Selventa Inc. of Cambridge, Mass., USA. Using a database of causal biological knowledge, the network modeling engine 112 may identify a network that links the perturbations 102 and the measurables 104. In certain implementations, the network modeling engine 112 extracts causal relationships between biological entities using the systems response profiles from the SRP engine 110 and networks previously generated in the literature. The database may be further processed to remove logical inconsistencies and generate new biological knowledge by applying homologous reasoning between different sets of biological entities, among other processing steps.

In certain implementations, the network model extracted from the database is based on reverse causal reasoning (RCR), an automated reasoning technique that processes networks of causal relationships to formulate mechanism hypotheses, and then evaluates those mechanism hypotheses against datasets of differential measurements. Each mechanism hypothesis links a biological entity to measurable quantities that it can influence. For example, measurable quantities can include an increase or decrease in concentration, number or relative abundance of a biological entity, activation or inhibition of a biological entity, or changes in the structure, function or logical of a biological entity, among others. RCR uses a directed network of experimentally-observed causal interactions between biological entities as a substrate for computation. The directed network may be expressed in Biological Expression Language™ (BEL™), a syntax for recording the inter-relationships between biological entities. The RCR computation specifies certain constraints for network model generation, such as but not limited to path length (the maximum number of edges connecting an upstream node and downstream nodes), and possible causal paths that connect the upstream node to downstream nodes. The output of RCR is a set of mechanism hypotheses that represent upstream controllers of the differences in experimental measurements, ranked by statistics that evaluate relevance and accuracy. The mechanism hypotheses output can be assembled into causal chains and larger networks to interpret the dataset at a higher level of interconnected mechanisms and pathways.

One type of mechanism hypothesis comprises a set of causal relationships that exist between a node representing a potential cause (the upstream node or controller) and nodes representing the measured quantities (the downstream nodes). This type of mechanism hypothesis can be used to make predictions, such as if the abundance of an entity represented by an upstream node increases, the downstream nodes linked by causal increase relationships would be inferred to be increase, and the downstream nodes linked by causal decrease relationships would be inferred to decrease.

A mechanism hypothesis represents the relationships between a set of measured data, for example, gene expression data, and a biological entity that is a known controller of those genes. Additionally, these relationships include the sign (positive or negative) of influence between the upstream entity and the differential expression of the downstream entities (for example, downstream genes). The downstream entities of a mechanism hypothesis can be drawn from a database of literature-curated causal biological knowledge. In certain implementations, the causal relationships of a mechanism hypothesis that link the upstream entity to downstream entities, in the form of a computable causal network model, are the substrate for the calculation of network changes by the NPA scoring methods.

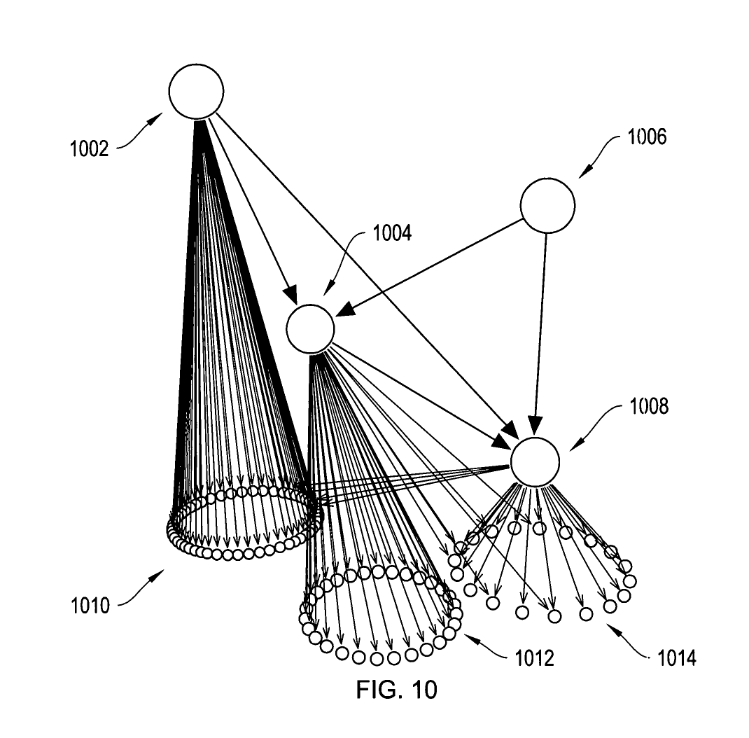

In certain embodiments, a complex causal network model of biological entities can be transformed into a single causal network model by collecting the individual mechanism hypothesis representing various features of the biological system in the model and regrouping the connections of all the downstream entities (e.g., downstream genes) to a single upstream entity or process, thereby representing the whole complex causal network model; this in essence is a flattening of the underlying graph structure. Changes in the features and entities of a biological system as represented in a network model can thus be assessed by combining individual mechanism hypotheses. In some implementations, a subset of nodes (referred to herein as “backbone nodes”) in a causal network model represents a first set of biological entities corresponding to entities that are not measured or that cannot be measured conveniently or economically, for example, biological mechanisms or activities of key actors in a biological system; and another subset of nodes (referred to herein as “supporting nodes”) represents a second set of biological entities in the biological system which can be measured and for which the values are experimentally determined and presented in datasets for computation, for example, the levels of expression of a plurality of genes in the biological system. FIG. 10 depicts an exemplary network that includes four backbone nodes 1002, 1004, 1006 and 1008 and edges between the backbone nodes and from the backbone nodes to groups of supporting gene expression nodes 1010, 1012 and 1014. Each edge in FIG. 10 is directed (i.e., representing the direction of a cause-and-effect relationship) and signed (i.e., representing positive or negative regulation). This type of network may represent a set of causal relationships that exists between certain biological entities or mechanisms, (e.g., ranging from quantities that are as specific as the increase in abundance or activation of a particular enzyme to quantities as complex as that which reflect the status of a growth factor signaling pathway) and other downstream entities (e.g., gene expression levels) that are positively or negatively regulated.

In certain implementations, the system 100 may contain or generate a computerized model for the mechanism of cell proliferation when the cells have been exposed to cigarette smoke. In such an example, the system 100 may also contain or generate one or more network models representative of the various health conditions relevant to cigarette smoke exposure, including but not limited to cancer, pulmonary diseases and cardiovascular diseases. In certain aspects, these network models are based on at least one of the perturbations applied (e.g., exposure to an agent), the responses under various conditions, the measureable quantities of interest, the outcome being studied (e.g., cell proliferation, cellular stress, inflammation, DNA repair), experimental data, clinical data, epidemiological data, and literature.

As an illustrative example, the network modeling engine 112 may be configured for generating a network model of cellular stress. The network modeling engine 112 may receive networks describing relevant mechanisms involved in the stress response known from literature databases. The network modeling engine 112 may select one or more networks based on the biological mechanisms known to operate in response to stresses in pulmonary and cardiovascular contexts. In certain implementations, the network modeling engine 112 identifies one or more functional units within a biological system and builds a larger network model by combining smaller networks based on their functionality. In particular, for a cellular stress model, the network modeling engine 112 may consider functional units relating to responses to oxidative, genotoxic, hypoxic, osmotic, xenobiotic, and shear stresses. Therefore, the network components for a cellular stress model may include xenobiotic metabolism response, genotoxic stress, endothelial shear stress, hypoxic response, osmotic stress and oxidative stress. The network modeling engine 112 may also receive content from computational analysis of publicly available transcriptomic data from stress relevant experiments performed in a particular group of cells.

When generating a network model of a biological mechanism, the network modeling engine 112 may include one or more rules. Such rules may include rules for selecting network content, types of nodes, and the like. The network modeling engine 112 may select one or more data sets from experimental data database 106, including a combination of in vitro and in vivo experimental results. The network modeling engine 112 may utilize the experimental data to verify nodes and edges identified in the literature. In the example of modeling cellular stress, the network modeling engine 112 may select data sets for experiments based on how well the experiment represented physiologically-relevant stress in non-diseased lung or cardiovascular tissue. The selection of data sets may be based on the availability of phenotypic stress endpoint data, the statistical rigor of the gene expression profiling experiments, and the relevance of the experimental context to normal non-diseased lung or cardiovascular biology, for example.

After identifying a collection of relevant networks, the network modeling engine 112 may further process and refine those networks. For example, in some implementations, multiple biological entities and their connections may be grouped and represented by a new node or nodes (e.g., using clustering or other techniques).

The network modeling engine 112 may further include descriptive information regarding the nodes and edges in the identified networks. As discussed above, a node may be described by its associated biological entity, an indication of whether or not the associated biological entity is a measurable quantity, or any other descriptor of the biological entity, while an edge may be described by the type of relationship it represents (e.g., a causal relationship such as an up-regulation or a down-regulation, a correlation, a conditional dependence or independence), the strength of that relationship, or a statistical confidence in that relationship, for example. In some implementations, for each treatment, each node that represents a measureable entity is associated with an expected direction of activity change (i.e., an increase or decrease) in response to the treatment. For example, when a bronchial epithelial cell is exposed to an agent such as tumor necrosis factor (TNF), the activity of a particular gene may increase. This increase may arise because of a direct regulatory relationship known from the literature (and represented in one of the networks identified by network modeling engine 112) or by tracing a number of regulation relationships (e.g., autocrine signaling) through edges of one or more of the networks identified by network modeling engine 112. In some cases, the network modeling engine 112 may identify an expected direction of change, in response to a particular perturbation, for each of the measureable entities. When different pathways in the network indicate contradictory expected directions of change for a particular entity, the two pathways may be examined in more detail to determine the net direction of change, or measurements of that particular entity may be discarded.

The computational methods and systems provided herein calculate NPA scores based on experimental data and computational network models. The computational network models may be generated by the system 100, imported into the system 100, or identified within the system 100 (e.g., from a database of biological knowledge). Experimental measurements that are identified as downstream effects of a perturbation within a network model are combined in the generation of a network-specific response score. Accordingly, at step 216, the network scoring engine 114 generates NPA scores for each perturbation using the networks identified at step 214 by the network modeling engine 112 and the SRPs generated at step 212 by the SRP engine 110. A NPA score quantifies a biological response to a treatment (represented by the SRPs) in the context of the underlying relationships between the biological entities (represented by the identified networks). The network scoring engine 114 may include hardware and software components for generating NPA scores for each of the networks contained in or identified by the network modeling engine 112.

The network scoring engine 114 may be configured to implement any of a number of scoring techniques, including techniques that generate scalar- or vector-valued scores indicative of the magnitude and topological distribution of the response of the network to the perturbation.

Additional scoring techniques may be advantageously applied in certain applications and may be extended to enable comparisons between different experiments on the same biological network (referred to herein as “comparability”) or comparisons between analogous biological networks between species, systems or mechanisms (referred to herein as “translatability”). A number of scoring techniques, as well as techniques for assessing comparability and translatability, are now described.

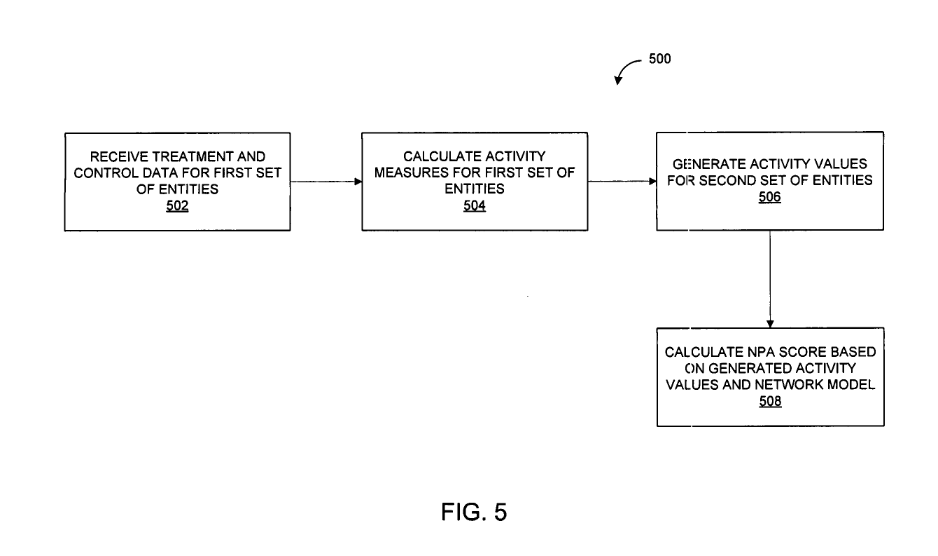

FIG. 5 is a flow diagram of an illustrative process 500 for quantifying the perturbation of a biological system in response to an agent. The process 500 may be implemented by the network scoring engine 114 or any other suitably configured component or components of the system 100, for example. In particular, a first set of biological entities may be measured (i.e., treatment data and control data are measured for the first set of biological entities), while a second set of biological entities may not be measured (i.e., not treatment or control data are measured for the second set of biological entities). Data may not be readily available (or may be available in a limited quantity) for the second set of biological entities for any number of reasons. As examples, data corresponding to the second set of biological entities may be particularly difficult to obtain, or the second set of biological entities may be related to another easily measurable set of biological entities, such that the data may be reasonably inferred from the measurable set.

To quantify the perturbation of a biological system in response to an agent, the network scoring engine 114 may calculate an NPA score, which is a numerical value that represents the responses of a biological mechanism to a perturbation. One way to calculate an NPA score is to use only data that is directly measured (i.e., corresponding to the first set of biological entities in the example above). However, this approach is limited to a subset of the data that may potentially be used to determine an impact of a perturbation on a biological mechanism. In particular, there may be another set of biological entities that is not directly measured (i.e., corresponding to the second set of biological entities in the example above), but may provide information for the NPA score. In this case, the unmeasured set of biological entities may be related to the measured set, such that the network scoring engine 114 may infer data related to the unmeasured set from the measurable set. Thus, an NPA score may be based on the measured data, the inferred data, or a combination of both. The process 500 in FIG. 5 describes a method for calculating an NPA score based on the inferred data.

At the step 502, the network scoring engine 114 receives treatment and control data for a first set of biological entities in a biological system. The treatment data corresponds to a response of the first set of biological entities to an agent, while the control data corresponds to the response of the first set of biological entities to the absence of the agent. The biological system includes the first set of biological entities (for which treatment and control data is received at the step 502), as well as a second set of biological entities (for which no treatment and control data may be received). Each biological entity in the biological system interacts with at least one other of the biological entities in the biological system, and in particular, at least one biological entity in the first set interacts with at least one biological entity in the second set. The relationship between biological entities in the biological system may be represented by a computational network model that includes a first set of nodes representing the first set of biological entities, a second set of nodes representing the second set of biological entities, and edges that connect the nodes and represent relationships between the biological entities. The computational network model may also include direction values for the nodes, which represent the expected direction of change between the control and treatment data (e.g., activation or suppression). Examples of such network models are described in detail above.

At the step 504, the network scoring engine 114 calculates activity measures for the biological entities in the first set of biological entities. Each activity measure in the first set of activity measures represents a difference between the treatment data and the control data for a particular biological entity in the first set. Because of the correspondence between the first set of biological entities and the first set of nodes in the computational network model, the step 504 also calculates activity measures for the first set of nodes in the computational network model. In some implementations, the activity measures may include a fold-change. The fold-change may be a number describing how much a node measurement changes going from an initial value to a final value between control data and treatment data, or between two sets of data representing different treatment conditions. The fold-change number may represent the logarithm of the fold-change of the activity of the biological entity between the two conditions. The activity measure for each node may include a logarithm of the difference between the treatment data and the control data for the biological entity represented by the respective node. In certain implementations, the computerized method includes generating, with a processor, a confidence interval for each of the generated scores.

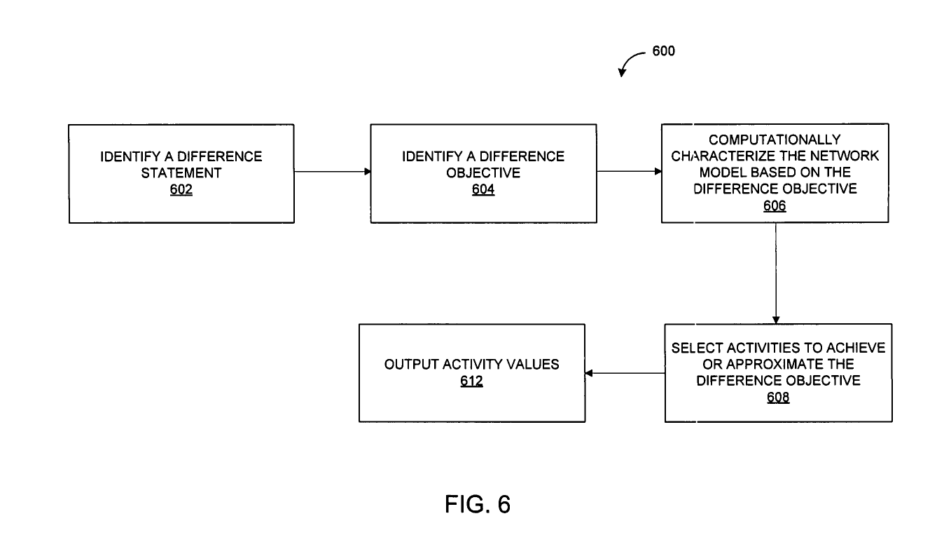

At the step 506, the network scoring engine 114 generates activity values for the biological entities in the second set of biological entities. Because no treatment and control data were received for the biological entities in the second set, the activity values generated at the step 506 represent inferred activity values, and are based on the first set of activity measures and the computational network model. The activity values inferred for the second set of biological entities (corresponding to a second set of nodes in the computational network model) may be generated according to any of a number of inference techniques; several implementations are described below with reference to FIG. 6. The activity values generated for non-measured entities at the step 506 illuminate the behavior of biological entities that are not measured directly, using the relationships between entities provided by the network model.

At the step 508, the network scoring engine 114 calculates an NPA score based on the activity values generated at the step 506. The NPA score represents the perturbation of the biological system to the agent (as reflected in the difference between the control and treatment data), and is based on the activity values generated at the step 506 and the computational network model. In some implementations, the NPA score calculated at the step 508 may be calculated in accordance with:

$$NPA ( G , β ) = \frac{1}{\vert \{ x -> y \} s . t . x , y ∉ {V}_{0} \vert} \sum {x -> y}_{s . t . x , y ∉ {V}_{0}} {( f ( x ) + sign ( x -> y ) f ( y ) )}^{2} , \qquad ( 1 )$$

where V₀ denotes the first set of biological entities (i.e., those for which treatment and control data are received at the step 502), f(x) denotes the activity value generated at the step 508 for the biological entity x, and sign(x→y) denotes the direction value of the edge in the computational network model that connects the node representing biological entity x to the node representing biological entity y. If the vector of activity values associated with the second set of biological entities is denoted f2, the network scoring engine 114 can be configured to calculate the NPA score via the quadratic form:

$$\begin{matrix} NPA = {f}_{2}^{T} Q {f}_{2} , \\ where & ( 2 ) \\ Q = \frac{1}{\vert \{ x -> y \} s . t . x , y ∉ {V}_{0} \vert} [ ( \begin{matrix}diag ( out {\vert}_{{l}^{2} ( V \backslash {V}_{0} )} ) + diag ( in {\vert}_{{l}^{2} ( V \backslash {V}_{0} )} ) - \\ ( - A - {A}^{T} )\end{matrix} ) {\vert}_{{l}^{2} ( V \backslash {V}_{0} )} ] ∈ {l}^{2} ( V \backslash {V}_{0} ) & ( 3 )\end{matrix}$$

diag(out) denotes the diagonal matrix with the out-degree of each node in the second set of nodes, diag(in) denotes the diagonal matrix with the in-degree of each node in the second set of nodes, and A denotes the adjacency matrix of the computational network model limited to only those nodes in the second set and defined in accordance with

$${A}_{xy} = \{ \begin{matrix}sign ( x -> y ) & if x -> y \\ 0 & else .\end{matrix} \qquad ( 4 )$$

If A is a weighted adjacency matrix, then element (x, y) of A may be multiplied by a weight factor w(x→y).

The step 508 may also include calculating confidence intervals for the NPA score. In some implementations, the activity values f2 are assumed to follow a multivariate normal distribution N(μ, Σ), then an NPA score calculated in accordance with Eq. 2 will have an associated variance that may be calculated in accordance with

var(f^{T}Qf)=2tr(QΣQΣ)+4μ^{T}QΣQμ. (5)

In some implementations, such as those that operate in accordance with Eq. 5, the NPA score has a quadratic dependence on the activity values. The network scoring engine 114 may be further configured to use the variance calculated in accordance with Eq. 5 to generate a conservative confidence interval by, among other methods, applying Chebyshev's inequality or relying on the central limit theorem.

FIG. 6 is a flow diagram of an illustrative process 600 for generating activity values for a set of nodes. The process 600 may be performed at step 506 of the process 500 of FIG. 5, for example, and is described as being performed by the network scoring engine 114 for ease of illustration. At step 602, the network scoring engine 114 identifies a difference statement. A difference statement may be an expression or other executable statement that represents the difference between the activity measure or value of a particular biological entity and the activity measure or value of biological entities to which the particular biological entity is connected. In the language of the computational network model representing the biological system of interest, a difference statement represents the difference between the activity measure or value of a particular node in the network model and the activity measure or value of nodes to which the particular node is connected via an edge. The difference statement may depend on any one or more of the nodes in the computational network model. In some embodiments, the difference statement depends on the activity values of each node in the second set of nodes discussed above with respect to the step 506 of FIG. 5 (i.e., those nodes for which no treatment or control data is available, and whose activity values are inferred from treatment or control data associated with other nodes and the computational network model).

In some implementations, the network scoring engine 114 identifies the following difference statement at the step 602:

$${\sum }_{x -> y} {( f ( x ) - sign ( x -> y ) f ( y ) )}^{2} w ( x -> y ) , \qquad ( 6 )$$

where f(x) denotes an activity value (for nodes x in the second set of nodes) or measure (for nodes x in the first set of nodes), sign(x→y) denotes the direction value of the edge in the computational network model that connects the node representing biological entity x to the node representing biological entity y, and w(x→y) denotes a weight associated with the edge connecting the nodes representing entities x and y. For ease of illustration, the remaining discussion will assume that w(x→y) is equal to one, but one of ordinary skill in the art will easily track non-unity weights through the discussion of the difference statement of Eq. 6 (i.e., by using a weighted adjacency matrix as described above with reference to Eq. 4).

The network scoring engine 114 may implement the difference statement of Eq. 6 in many difference ways, including any of the following equivalent statements:

$${\sum }_{x -> y} {( f ( x ) - sign ( x -> y ) f ( y ) )}^{2} = {\sum }_{x} {\sum }_{y \text{:} x -> y} {f ( x )}^{2} + {f ( y )}^{2} - 2 sign ( x -> y ) f ( x ) f ( y ) = {\sum }_{x} {f ( x )}^{2} \cdot out ( x ) + {\sum }_{y} {f ( y )}^{2} \cdot in ( y ) - 2 {\sum }_{x -> y} sign ( x -> y ) f ( x ) f ( y ) = {f}^{T} ( diag ( out ) + diag ( in ) ) f - {f}^{T} ( A + {A}^{T} ) f . \qquad ( 7 )$$

At the step 604, the network scoring engine 114 identifies a difference objective. The difference objective represents an optimization goal for the value of the difference statement towards which the network scoring engine 114 will select the activity values for the second set of biological entities. The difference objective may specify that the difference statement is to be maximized, minimized, or made as close as possible to a target value. The difference objective may specify the biological entities for which activity values are to be chosen, and may establish constraints on the range of activity values that are allowed for each entity. In some implementations, the difference objective is to minimize the difference statement of Eq. 6 over all biological entities in the second set of nodes discussed above with reference to the step 506 of FIG. 5, with the constraint that the activities of the first set of biological entities (i.e., those for which treatment and control data is available) be equal to the activity measures calculated at the step 504 of FIG. 5. This difference objective may be written as the following computational optimization problem:

argmin_{fεl}_{²}₍ᵥ₎Σ_{x→y}(f(x)−sign(x→y)f(y))²·w(x→y) such that f|ᵥ_{₀}=β, (8)

where β represents the activity measure calculated at the step 504 of FIG. 5 for each of the entities in the first set.

To address the difference objective identified at the step 604, the network scoring engine 114 is configured to proceed to the step 606 to computationally characterize the network model based on the difference objective. The computational network model representing the biological system may be characterized in any number of ways (e.g., via a weighted or non-weighted adjacency matrix A as discussed above). Different characterizations may be better suited to different difference objectives, improving the performance of the network scoring engine 114 in calculating NPA scores. For example, when the difference objective is formulated according to Eq. 8, above, the network scoring engine 114 may be configured to characterize the computational network model using a signed Laplacian matrix defined in accordance with

L=diag(out)+diag(in)−(A+A^{T}). (9)

Given this characterization, the difference objective of Eq. 8 can be represented as

argmin_{fεl}_{²}₍ᵥ₎f^{T}Lf such that f|ᵥ_{₀}=β. (10)

The network scoring engine 114 may be configured to characterize the computational network model at a second level by partitioning the network model into four components: connections within the first set of nodes, connections from the first set of nodes to the second set of nodes, connections from the second set of nodes to the first set of nodes, and connections within the second set of nodes. Computationally, the network scoring engine 114 may implement this additional characterization by partitioning the Laplacian matrix into four sub-matrices (one for each of these components) and partitioning the vector of activities f into two sub-vectors (one for the activities of the first set of nodes f₁ and one for the activities of the second set of nodes f₂). This recharacterization of the difference statement of Eq. 10 may be written as:

$${f}^{T} ( \begin{matrix}{L}_{1} & {L}_{2} \\ {L}_{2}^{T} & {L}_{3}\end{matrix} ) f = ( {f}_{1}^{T} {f}_{2}^{T} ) ( \begin{matrix}{L}_{1} & {L}_{2} \\ {L}_{2}^{T} & {L}_{3}\end{matrix} ) ( \begin{matrix}{f}_{1} \\ {f}_{2}\end{matrix} ) = {f}_{1}^{T} {L}_{1} {f}_{1} + {f}_{1}^{T} {L}_{2} {f}_{2} + {f}_{2}^{T} {L}_{2}^{T} {f}_{1} + {f}_{2}^{T} {L}_{3} {f}_{2} . \qquad ( 11 )$$

At the step 606, the network scoring engine 114 selects activity values to achieve or approximate the difference objective. Many different computational optimization routines are known in the art, and may be applied to any difference objective identified at the step 604. In implementations in which the difference objective of Eq. 10 is identified at the step 604, the network scoring engine 114 may be configured to select the values of f2 that minimize the expression of Eq. 11 by taking a (numerical or analytical) derivative of Eq. 11 with respect to f2, setting the derivative equal to zero, and rearranging to isolate an expression for f2. Since

$$\frac{\partial }{\partial {f}_{2}} ( {f}^{T} L f ) = 2 {L}_{2}^{T} {f}_{1} + 2 {L}_{3} {f}_{2} , \qquad ( 12 )$$

the network scoring engine 114 may be configured to calculate f2 in accordance with:

f₂=−L₃⁻¹L₂^{T}f₁≡Kf₁. (13)

Since f1 is a vector of the calculated activity measures for the first set of biological entities (for which treatment and control data is available), the activity values for the second set of biological entities may be represented as a linear combination of the calculated activity measures in accordance with Eq. 13. As in Eq. 13, the activity values may depend on edges between nodes in the first set of nodes and nodes in the second set of nodes within the first computational network model (i.e., L₂), and may also depend on edges between nodes in the second set of nodes within the computational causal network model (i.e., L₃). In some implementations (such as those that operate in accordance with Eq. 13), the activity values do not depend on edges between nodes in the first set of nodes within the computational network model.

At the step 608, the network scoring engine 114 provides the activity values generated at the step 606. In some implementations, the activity values are displayed for a user. In some implementations, the activity values are used at the step 508 of FIG. 5 to calculate an NPA score as described above. In some implementations, variance and confidence information for the activity values may also be generated at the step 608. For example, if the activity values and measures may be assumed to approximately follow a multivariate normal distribution, N(μ, Σ), then Af will also follow a multivariate normal distribution with

var(Af)=AΣA^{T}. (14)

In this case, confidence intervals for the inferred activity values may be calculated using standard statistical techniques with A=−L₃⁻¹L₂^{T} and Σ=diag(var(β)).

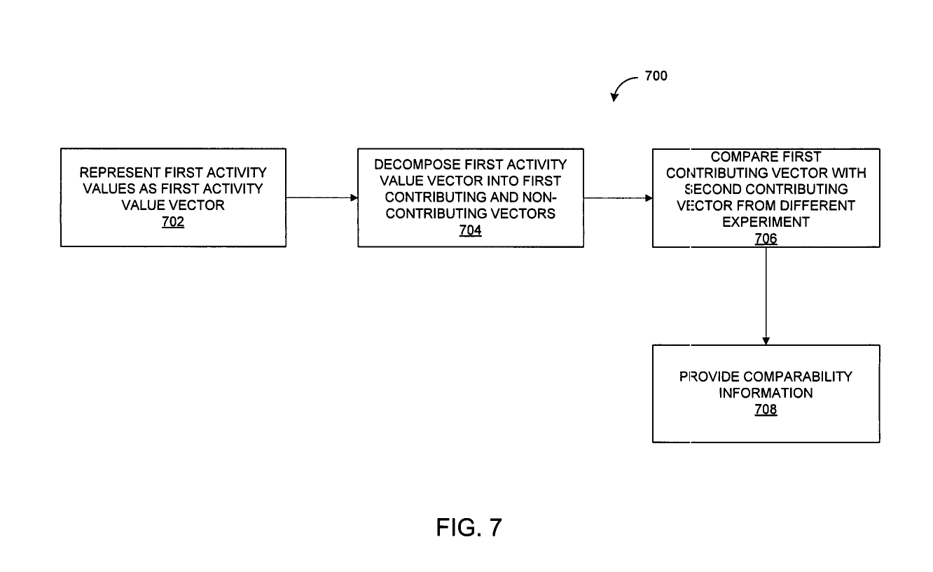

The activity measures calculated at the step 504 of FIG. 5 and the activity values generated at the step 506 of FIG. 5 (e.g., in accordance with the process 600 of FIG. 6) may be used to provide comparability information that reflects the concordance or discordance between different agents and treatment conditions applied to the same biological system. FIG. 7 is a flow diagram of an illustrative process 700 for providing comparability information. The process 700 may be executed by the network scoring engine 114 or any other suitably configured component or components of the system 100, for example, after generating activity values for the second set of nodes at the step 506 of FIG. 5.

At the step 702, the network scoring engine 114 represents a first set of activity values as a first activity value vector. This type of representation was discussed above with reference to Eq. 11, in which a set of activity values was represented as the vector f2. At the step 704, the network scoring engine 114 decomposes the first activity value vector into a first contributing vector and a first non-contributing vector. The first contributing vector and the first non-contributing vector depend on the relationship between the activity value vector and the NPA score. If the NPA score is denoted as a transformation g of the first activity value vector v1, such that

NPA=g(h(v1)), (15)

then v1 may be decomposed at the step 704 into the sum of two vectors v1c and v1nc such that

v1=v1c+v1nc (16)

and

g(v1nc)=0. (17)

Mathematically, the non-contributing vector v1nc is said to be in the kernel of the transformation h when g is strictly positive definite, while the contributing vector v1c is said to be in the image space of the transformation h. Standard computational techniques can be applied to determine kernels and image spaces of various types of transformations. If the network scoring engine 114 calculates an NPA score from an activity value vector v1 in accordance with Eqs. 5 and 13, then the kernel of that NPA score transformation is the kernel of the matrix product (L₃⁻¹L₂^{T}) and the image space of that NPA score transformation is the image space of the matrix product (L₃⁻¹L₂^{T}). Thus, the activity value vector can be decomposed into a contributing component v1c in the image space of the matrix product (L₃⁻¹L₂^{T}) and a non-contributing component v1nc in the kernel of the matrix product (L₃⁻¹L₂^{T}) using standard computational projection techniques, and the NPA may not be dependent on the non-contributing component v1nc.

Since an NPA score may be computed as a quadratic form (as shown above), the network scoring engine 114 may generate a significant (with respect to the biological variability) score even though the input data do not reflect actual perturbation of the mechanisms in the model. To assess if a network is really perturbed (i.e., that the biology described in the model is reflected in the data), companion statistics may be used to help determine whether the extracted signal is specific to the network structure or is inherent within the collected data. Several types of permutation tests may be particularly useful in assessing whether the observed signal is more representative of a property inherent to the data or the structure given by the causal biological network model.

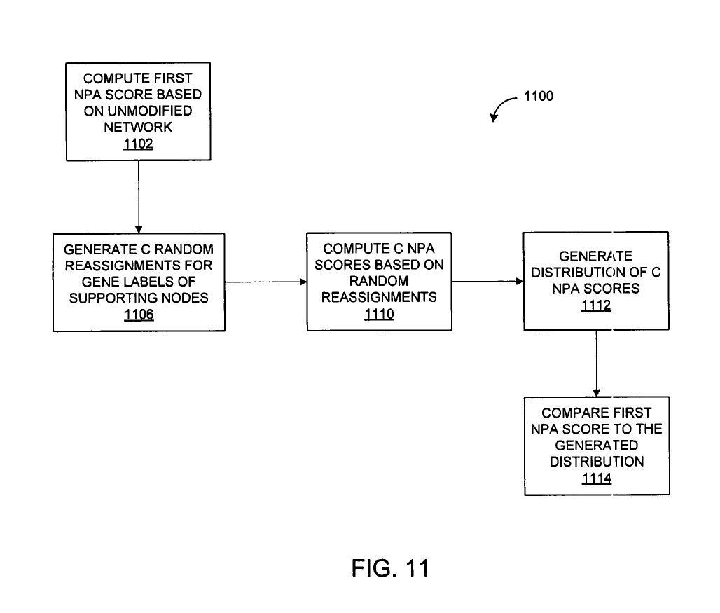

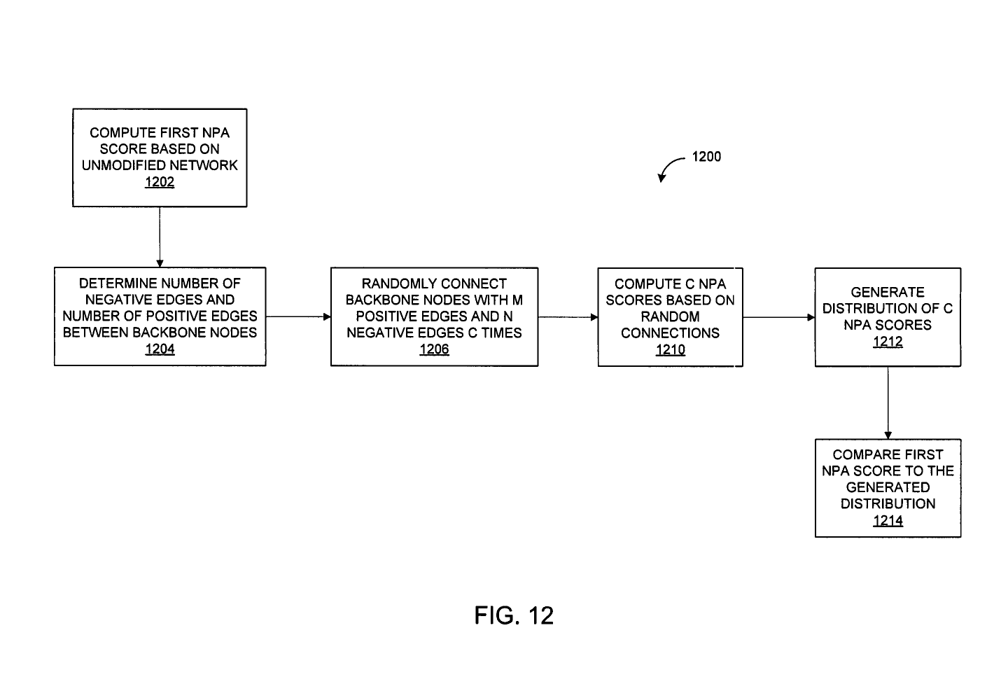

FIGS. 11 and 12 illustrate processes 1100 and 1200 that can be used by the network scoring engine 114 for determining the statistical significance of a proposed NPA score given a causal network model and specific datasets. Determining the statistical significance of a proposed NPA score can be useful for indicating whether the biological system that is being modeled by the network has been perturbed. To determine the statistical significance of a proposed NPA score, the network scoring engine 114 may subject the data to one or both tests as described below.

Both tests (referred to herein each as a permutation test) are based on generating random permutations of one or more aspects of the causal network model, using the resulting test models to compute test NPA scores based on the same datasets and algorithms that generated the proposed NPA score, and comparing or ranking the test NPA scores with the proposed NPA score to determine statistical significance of the proposed NPA score. The aspects of a causal network model that may be randomly assorted to generate the test models include the labels of the supporting nodes, the edges connecting the backbone nodes to the supporting nodes, or the edges that connect backbone nodes to each other.

In one implementation, a permutation test referred to herein as an “O-statistic” test, assesses the importance of the positions of the supporting nodes within the causal network model. The process 1100 includes a method to assess the statistical significance of a computed NPA score. In particular, at step 1102, a first proposed NPA score is computed based on the network based on knowledge of causal relationship of entities in the biological system, also referred to as an unmodified network. At step 1106, the gene labels and as a result the corresponding values of each supporting node are randomly reassigned among the supporting nodes in the network model. The random reassignment is repeated a number of times, e.g., C times, and at step 1112, the test NPA scores are computed based on the random reassignments, resulting in a distribution of C test NPA scores. The network scoring engine 114 may compute the proposed and test NPA scores according to any of the methods described above for computing an NPA score based on the network. At step 1114, the proposed NPA score is compared to or ranked against the distribution of test NPA scores to determine the statistical significance of the proposed NPA score.

In certain implantation, the methods of quantifying the perturbation of a biological system comprise computing a proposed NPA score based on a causal network model, and determining the statistical significance of the score. The significance can be computed by a method comprising reassigning randomly the labels of the supporting nodes of a causal network model to create a test model, computing a test NPA score based on a test model, and comparing the proposed NPA score and the test NPA scores to determine whether the biological system is perturbed. The labels of the supporting nodes are associated with the activity measures.

The integer C may be any number determined by the network scoring engine and may be based on a user input. The integer C may be sufficiently large such that the resulting distribution of NPA scores based on the random reassignments is approximately smooth. The integer C may be fixed such that the reassignments are performed a predetermined number of times. Alternatively, the integer C may vary depending on the resulting NPA scores. For example, the integer C may be iteratively increased, and additional reassignments may be performed if the resulting NPA distribution is not smooth. In addition, any other additional requirements for the distribution may be used, such as increasing C until the distribution resembles a certain form, such as Gaussian or any other suitable distribution. In certain implementations, the integer C ranges from about 500 to about 1000.

At step 1110, the network scoring engine 114 computes C NPA scores based on the random reassignments generated at step 1106. In particular, an NPA score is computed for each reassignment generated at step 1106. In certain implementations, all the C reassignments are first generated at step 1106, and then the corresponding NPA scores are computed based on the C reassignments at step 1110. In other implementations, a corresponding NPA score is computed after each set of reassignment is generated, and this process is repeated C times. The latter scenario may save on memory costs and may be desirable if the value for C is dependent on previously computed N values. At step 1112, the network scoring engine 114 aggregates the resulting C NPA scores to form or generate a distribution of NPA values, corresponding to the random reassignments generated at step 1106. The distribution may correspond to a histogram of the NPA values or a normalized version of the histogram.

At step 1114, the network scoring engine 114 compares the first NPA score to the distribution of NPA scores generated at step 1112. As an example, the comparison may include determining a “p-value” representative of a relationship between the proposed NPA score and the distribution. In particular, the p-value may correspond to a percentage of the distribution that is above or below the proposed NPA score value. A p-value that is small, for example less than 0.5%, less than 1%, less than 5%, or any other fraction, indicates that the proposed NPA score is statistically significant. For example, a proposed NPA score with a low p-value (<0.05 or below 5%, for example) computed at step 1114 indicates that the proposed NPA score is high relative to a significant number of the test NPA scores resulting from the random gene label reassignments.

In certain implementation, another permutation test referred to herein as a “K-statistic” test, assesses the importance of the structure of the backbone nodes within the causal network model. The process 1200 includes a method to assess the statistical significance of a proposed NPA score. The process 1200 is similar to the process 1100 in that an aspect of the causal network model is randomly assorted to create a plurality of test models whereupon a plurality of test NPA scores are computed. The causal network model that is built on knowledge of causal relationship of entities in the biological system, also referred to as an unmodified network. In such a model, an edge may be signed, and thus an edge may represent a positive or negative relationship between two backbone nodes. Accordingly, the causal network model comprises n edges that connect backbone nodes resulting in a positive influence, and m edges that connect backbone nodes resulting in a negative influence.

At step 1202, a proposed NPA score is computed based on the network built on knowledge of causal relationship of entities in the biological system. Then, at step 1204, a number n of negative edges and a number m of positive edges are determined. At step 1206, pairs of backbone nodes are each randomly connected with one of the n negative edges or one of the m positive edges. This process of generating the random connections with n+m number of edges is repeated C times. As previously described, the number of iterations C, can be determined by user input or by the smoothness of the distribution of test NPA scores. At step 1212, a plurality of test NPA scores are computed based on a plurality of test models comprising backbone nodes that are connected randomly to other backbone nodes. The network scoring engine 114 may compute the proposed and test NPA scores according to any of the methods described above for computing an NPA score based on the network. At step 1214, the proposed NPA score is compared to or ranked against a distribution of test NPA scores to determine the statistical significance of the proposed NPA score.

At step 1210, the network scoring engine 114 computes C NPA scores based on the random reconnections formed at step 1206. At step 1212, the network scoring engine 114 aggregates the resulting C NPA scores to generate a distribution of test NPA values, based on the test models resulting from the random reconnections generated at step 1106. The distribution may correspond to a histogram of the NPA values or a normalized version of the histogram.

At step 1214, the network scoring engine 114 compares the proposed NPA score to the distribution of NPA scores generated at step 1212. As an example, the comparison may include determining a “p-value” representative of a relationship between the proposed NPA score and the distribution. In particular, the p-value may correspond to a percentage of the distribution that is above or below the proposed NPA score value. A p-value that is small, for example less than 0.1%, less than 0.5%, less than 1%, less than 5%, or any intermediate fractions, indicates that the proposed NPA score is statistically significant. For example, a proposed NPA score with a low p-value (<0.05 or below 5%, for example) computed at step 1214 indicates that the proposed NPA score is high relative to a significant number of the test NPA scores resulting from the random reconnections of backbone nodes.

In certain implementations, it may be required that both p-values (computed in FIGS. 11 and 12) are low for the proposed NPA score to be considered statistically significant. In other implementations, the network scoring engine 114 may require one or more p-values to be low in order to find the proposed NPA score to be significant.

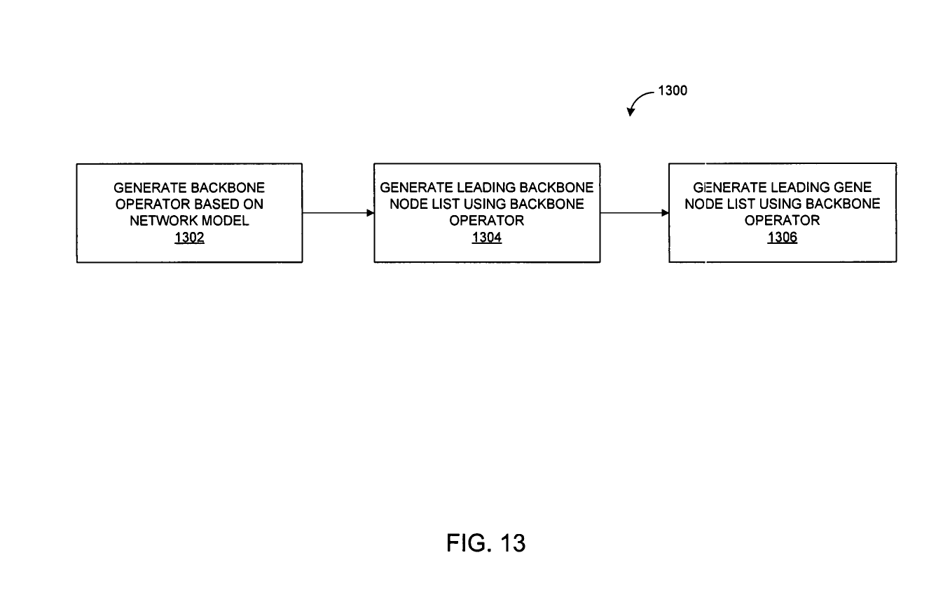

FIG. 13 is a flow diagram of an illustrative process 1300 for identifying leading backbone and gene nodes. At step 1302, the network scoring engine 114 generates a backbone operator based on the identified network model. The backbone operator acts on a vector of the activity measures of the supporting nodes and outputs a vector of activity values for the backbone nodes. A suitable backbone operator in some implementations is the operator K defined above in Eq. 13.

At step 1304, the network scoring engine 114 generates a list of leading backbone nodes using the backbone operator generated at step 1302, The leading backbone nodes may represent the most significant backbone nodes identified during the analysis of the treatment and control data and the causal biological network model. To generate this list, the network scoring engine 114 may use the backbone operator to form a kernel that can then be used in an inner product between the vector of activity values for the backbone nodes and itself. In some implementations, the network scoring engine 114 generates the list of leading backbone nodes by ordering the terms in the sum that results from such an inner product in decreasing order, and selecting either a fixed number of the nodes corresponding to the largest contributors to the sum or the number of the most significantly contributing nodes required to achieve a specified percentage of the total sum (e.g., 60%). Equivalently, the network scoring engine 114 may generate the leading backbone nodes list by including the backbone nodes that make up 80% of the NPA score by computing the cumulative sum of the ordered terms of Eq. 1. As discussed above, this cumulative sum can be calculated as the cumulative sum of the terms of the following inner product (using the backbone operator K):

f₁^{T}K^{T}Kf₁. (18)

Thus, the identification of leading nodes depends both on activity measures and network topology.

At step 1306, the network scoring engine 114 generates a list of leading gene nodes using the backbone operator generated at step 1302. As shown by Eq. 2, an NPA score may be represented as a quadratic form in the fold-changes. Thus, in some implementations, a leading gene list is generated by identifying the terms of the ordered sum of the following scalar product:

(f₁|L₂(L₃⁻¹)^{T}L₃⁻¹L₂^{T}f₁). (19)

Both ends of a leading gene list may be important as the genes contributing negatively to the NPA score also have biological significance.

In some implementations, the network scoring engine 114 also generates a structural importance value for each gene at step 1306. The structural importance value is independent of the experimental data and represents the fact that some genes might be more important to inferring the value of the backbone nodes than others due to the gene's position in the model. The structural importance may be defined for gene j by

Iⱼ=Σᵢ₌₁^{N}|(L₃⁻¹L₂^{T})ᵢⱼ| (20)

The biological entities in the leading backbone node list and the genes in the leading gene node list are candidates for biomarkers of activation of the underlying networks by the treatment condition (relative to the control condition). These two lists may be used separately or together to identify targets for future research, or may be used in other biomarker identification processes, as described below.

Referring now to FIG. 7, in some implementations, the network scoring engine 114 decomposes the first activity vector at the step 704 into non-contributing and contributing components, respectively, based on the kernel and image space of the following Laplacian matrix:

Lₗ_{²}_{(v\v}_{ₒ}₎=(diag(out|ₗ_{²}_{(v\v}_{₀}₎)+diag(in|ₗ_{²}_{(v\v}_{₀}₎)−(A+A^{T}))|ₗ_{²}_{(v\v}_{₀}₎εl²(V\V₀) (21)

in which the computational network model has been restricted to nodes corresponding to biological entities in the second set of biological entities as discussed above with reference to the step 506 of FIG. 5. The network scoring engine 114 may be further configured to compute a “signed” diffusion kernel as the matrix exponential of the Laplacian of Eq. 21 and project the first activity value vector onto the spectral components to generate at least one contributing component for further analysis, as described below.

At the step 706, the network scoring engine 114 compares the first contributing vector (determined at the step 704) with a second contributing vector determined from a second set of activity values from a different experiment. To determine this second contributing vector, the steps 702 and 704 may be repeated using different treatment and control data for the first set of nodes (per FIG. 5). In some embodiments, the same treatment and/or control data may be used to determine the second contributing vector. The second contributing vector represents the component of the activity values derived from a different experiment with different treatment (and optionally different control data) that contribute to an NPA score for the different experiment. Since the biological system of interest in both experiments is the same, the underlying computational network model is the same and thus the second non-contributing and contributing vectors depend on the kernel of the matrix product (L₃⁻¹L₂^{T}) and the image space of the matrix product (L₃⁻¹L₂^{T}), respectively.

At the step 708, the network scoring engine 114 provides comparability information based on the comparison of the step 706. In some implementations, the comparability information is a correlation between the first and second contributing vectors. In some implementations, the comparability information is a distance between the first and second contributing vectors. Any of a number of techniques for comparing vectors may be used to provide comparability information at the step 708.

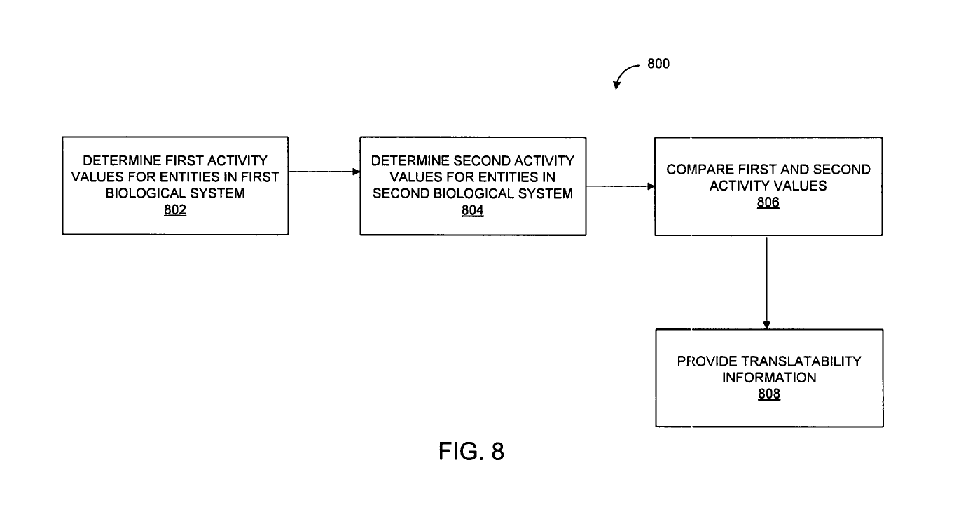

The activity measures calculated at the step 504 of FIG. 5 and the activity values generated at the step 506 of FIG. 5 (e.g., in accordance with the process 600 of FIG. 6) may be used to provide translatability information that reflects the degree to which two different biological systems respond analogously to perturbation by the same agent or treatment conditions. In an example, the two different biological systems may be any combination of an in vitro system, an in vivo system, a mouse system, a rat system, a non-human primate system, and a human system. FIG. 8 is a flow diagram of an illustrative process 800 for providing translatability information. The process 800 may be executed by the network scoring engine 114 or any other suitably configured component or components of the system 100, for example, after generating activity values for the second set of nodes at the step 506 of FIG. 5. At the step 802, the network scoring engine 114 determines a first set of activity values for entities in a first biological system, and at the step 804, the network scoring engine 114 determines a second set of activity values for entities in a second biological system. Each of the first and second biological systems is represented by corresponding first and second computational network models. The activity values may be determined in accordance with the step 506 of FIG. 5 or the process 600 of FIG. 6, for example.

At the step 806, the network scoring engine 114 compares the first set of activity values determined at the step 802 with the second set of activity values determined at the step 804. In some implementations, the network scoring engine 114 is configured to analyze the following relationships between the first activity values for the first biological system (V⁽¹⁾) and the second activity values for the second biological system (V⁽²⁾):

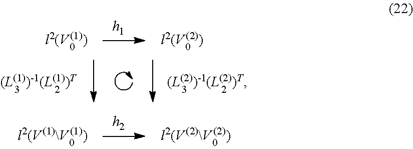

where h1 and h2 represent a mapping between the first and second biological systems at the activity measure level (e.g., a mapping from the treatment and control data for an experiment on the first biological system to the treatment and control data for an experiment on the second biological system) and a mapping between the first and second biological systems at the inferred activity value level (e.g., a mapping from the inferred activity values for the first biological system to the inferred activity values for the second biological system), respectively. Though these mappings are likely unknown, the network scoring engine 114 may be configured to determine information about these mappings by performing comparisons at the activity measure level and at the inferred activity value level. For example, in some implementations, the network scoring engine 114 is configured to calculate a correlation between activity values projected into the image space of the respective matrix product (L₃⁽ⁱ⁾)⁻¹(L₂⁽ⁱ⁾)^{T}, or projected onto spectral components of an associated matrix (such as the Laplacian matrix discussed above with reference to Eq. 21). In some implementations, the network scoring engine 114 may compare the first and second sets of activity values by applying a kernel canonical correlation analysis (KCCA) technique, many of which are well-known in the art.

At the step 808, the network scoring engine 114 provides translatability information based on the comparison at the step 806. As discussed above with reference to the comparability information provided at the step 708 of FIG. 7, any of a number of techniques for comparing vectors may be used to provide comparability information at the step 808. For example, in some implementations, the network scoring engine 114 is configured to calculate a correlation between activity values projected into the image space of the respective matrix product (L₃⁽ⁱ⁾)⁻¹(L₂⁽ⁱ⁾)^{T}, or projected onto spectral components of an associated matrix (such as the Laplacian matrix discussed above with reference to Eq. 21). In some implementations, the network scoring engine 114 may compare the first and second sets of activity values and provide translatability information by applying a kernel canonical correlation analysis (KCCA) technique, many of which are well-known in the art.

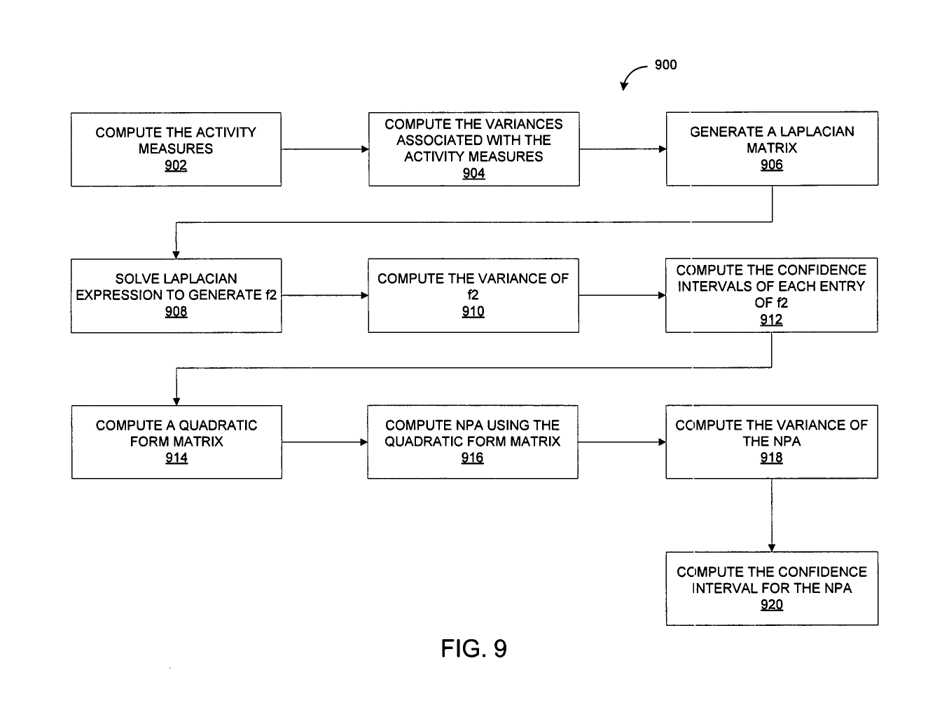

FIG. 9 is a flow diagram of an illustrative process 900 for calculating confidence intervals for activity values and NPA scores. At the step 902, the network scoring engine 114 computes the activity measures (denoted here as β) as described above with reference to step 504 of FIG. 5. In some implementations, the activity measures may be a fold-change value or a weighted fold-change value (weighted, e.g., using an associated false non-discovery rate) determined by the Limma R statistical analysis package or by another standard statistical technique. At the step 904, the network scoring engine 114 computes the variances associated with the activity measures (or weighted activity measures) calculated at the step 902. In some implementations, a matrix Σ is defined as Σ=diag(var(β)) at the step 904. At the step 906, the structure of the relevant network is used to generate a Laplacian matrix (e.g., as described below with reference to Eq. 9). The network may be weighted, signed, and directed, or any combination thereof. At the step 908, the network scoring engine 114 solves the Laplacian expression of Eq. 12 with the left hand side equal to zero to generate f₂ (the vector of activity values). At the step 910, the network scoring engine 114 computes the variance of the vector of activity values. In some implementations, this vector is calculated in accordance with

var(f₂)=L₃L₂^{T}ΣL₂L₃^{T}, (23)

where L₂ and L₃ are as defined in Eq. 11. At the step 912, the network scoring engine 114 computes the confidence intervals of each entry of f₂ in accordance with

$${f}_{2} ( x ) \pm z ( 1 - \frac{α}{2} ) √ var ( {f}_{2} ( x ) ) , \qquad ( 24 )$$

where

$$z ( 1 - \frac{α}{2} )$$

is the associated N(0,1) quantile (e.g., 1.96 if a=0.05). At the step 914, the network scoring engine 114 computes a quadratic form matrix to be used at the step 916 in the step 916 to compute an NPA score. In some implementations, the quadratic form matrix is computed in accordance with Eq. 3, above. At the step 916, the network scoring engine 114 computes an NPA score using the quadratic form matrix Q in accordance with Eq. 2. At the step 918, the network scoring engine 114 computes a variance of the NPA score computed at the step 916. In some implementations, this variance is computed in accordance with

var(NPA)=var(f₂^{T}Qf₂)=2tr(QΣ²QΣ²)+4f₂^{T}QΣ²Qf₂, (25)

where Σ²=var(f₂). At the step 920, the network scoring engine 114 computes a confidence interval for the NPA score computed at the step 916. In some implementations, the confidence interval is computed in accordance with

$$\begin{matrix}NPA \pm √ ( \frac{1}{1 - α} ) √ var ( NPA ) . \\ Or & ( 26 ) \\ NPA \pm z ( 1 - \frac{α}{2} ) √ var ( NPA ) . & ( 27 )\end{matrix}$$

FIG. 14 is a block diagram of a distributed computerized system 1400 for quantifying the impact of biological perturbations. The components of the system 1400 are similar to those in the system 100 of FIG. 1, but the arrangement of the system 100 is such that each component communicates through a network interface 1410. Such an implementation may be appropriate for distributed computing over multiple communication systems including wireless communication system that may share access to a common network resource, such as “cloud computing” paradigms.

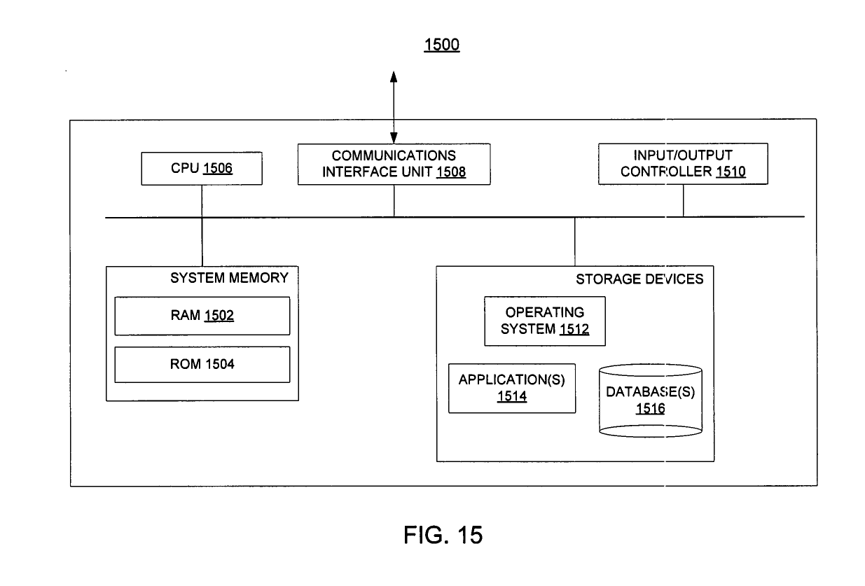

FIG. 15 is a block diagram of a computing device, such as any of the components of system 100 of FIG. 1 or system 1100 of FIG. 11 for performing processes described herein. Each of the components of system 100, including the systems response profile engine 110, the network modeling engine 112, the network scoring engine 114, the aggregation engine 116 and one or more of the databases including the outcomes database, the perturbations database, and the literature database may be implemented on one or more computing devices 1500. In certain aspects, a plurality of the above-components and databases may be included within one computing device 1500. In certain implementations, a component and a database may be implemented across several computing devices 1500.

The computing device 1500 comprises at least one communications interface unit, an input/output controller 1510, system memory, and one or more data storage devices. The system memory includes at least one random access memory (RAM 1502) and at least one read-only memory (ROM 1504). All of these elements are in communication with a central processing unit (CPU 1506) to facilitate the operation of the computing device 1500. The computing device 1500 may be configured in many different ways. For example, the computing device 1500 may be a conventional standalone computer or alternatively, the functions of computing device 1500 may be distributed across multiple computer systems and architectures. The computing device 1500 may be configured to perform some or all of modeling, scoring and aggregating operations. In FIG. 15, the computing device 1500 is linked, via network or local network, to other servers or systems.

The computing device 1500 may be configured in a distributed architecture, wherein databases and processors are housed in separate units or locations. Some such units perform primary processing functions and contain at a minimum a general controller or a processor and a system memory. In such an aspect, each of these units is attached via the communications interface unit 1508 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 1506 comprises a processor, such as one or more conventional microprocessors and one or more supplementary co-processors such as math co-processors for offloading workload from the CPU 1506. The CPU 1506 is in communication with the communications interface unit 1508 and the input/output controller 1510, through which the CPU 1506 communicates with other devices such as other servers, user terminals, or devices. The communications interface unit 1508 and the input/output controller 1510 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 1506 is also in communication with the data storage device. The data storage device may comprise an appropriate combination of magnetic, optical or semiconductor memory, and may include, for example, RAM 1502, ROM 1504, flash drive, an optical disc such as a compact disc or a hard disk or drive. The CPU 1506 and the data storage device each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 1506 may be connected to the data storage device via the communications interface unit 1508. The CPU 1506 may be configured to perform one or more particular processing functions.

The data storage device may store, for example, (i) an operating system 1512 for the computing device 1500; (ii) one or more applications 1514 (e.g., computer program code or a computer program product) adapted to direct the CPU 1506 in accordance with the systems and methods described here, and particularly in accordance with the processes described in detail with regard to the CPU 1506; or (iii) database(s) 1516 adapted to store information that may be utilized to store information required by the program. In some aspects, the database(s) includes a database storing experimental data, and published literature models.

The operating system 1512 and applications 1514 may be stored, for example, in a compressed, an uncompiled and an encrypted format, and may include computer program code. The instructions of the program may be read into a main memory of the processor from a computer-readable medium other than the data storage device, such as from the ROM 1504 or from the RAM 1502. While execution of sequences of instructions in the program causes the CPU 1506 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to modeling, scoring and aggregating as described herein. The program also may include program elements such as an operating system 1512, a database management system and “device drivers” that allow the processor to interface with computer peripheral devices (e.g., a video display, a keyboard, a computer mouse, etc.) via the input/output controller 1510.

The term “computer-readable medium” as used herein refers to any non-transitory medium that provides or participates in providing instructions to the processor of the computing device 1500 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 1506 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 1500 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

While implementations of the disclosure have been particularly shown and described with reference to specific examples, it should be understood by those skilled in the art that various changes in form and detail may be made therein without departing from the scope of the disclosure as defined by the appended claims. The scope of the disclosure is thus indicated by the appended claims and all changes which come within the meaning and range of equivalency of the claims are therefore intended to be embraced.

The systems and methods described herein have been tested using a well-understood cell culture experiment. Normal human bronchial epithelial (NHBE) cells were treated with exposure to PD-0332991, a CDK4/6 inhibitor (CDKI) which arrests the cells in G1. The treated cells were then allowed to re-enter the cell cycle by removal of the CDKI from the media and washing. Re-entry of the cell cycle was experimentally confirmed by labeling the cells fluorescently in S-phase at 2, 4, 6 and 8 hours after the CDKI was removed and the cells were washed. The gene transcription profiles of cells that were sampled 2, 4, 6, and 8 hours after the removal of the CDKI, were obtained. Profiles of cells that were continuously exposed to CDKI in media were also obtained. To identify biological processes and mechanisms that were differentially activated when CDKI was removed, network perturbation amplitude scores were calculated using gene transcription profiles of the washed cells obtained at various time point. For the computation of a NPA score for the perturbation associated with the removal of CDKI, a cell cycle subnetwork that comprises 127 nodes and 240 edges, was used. It is a subnetwork of the cell proliferation network model published in Schlage et al. (2011, “A computable cellular stress network model for non-diseased pulmonary and cardiovascular tissue” BMC Syst Biol. Oct 19; 5:168, which is incorporated herein by reference in its entirety).

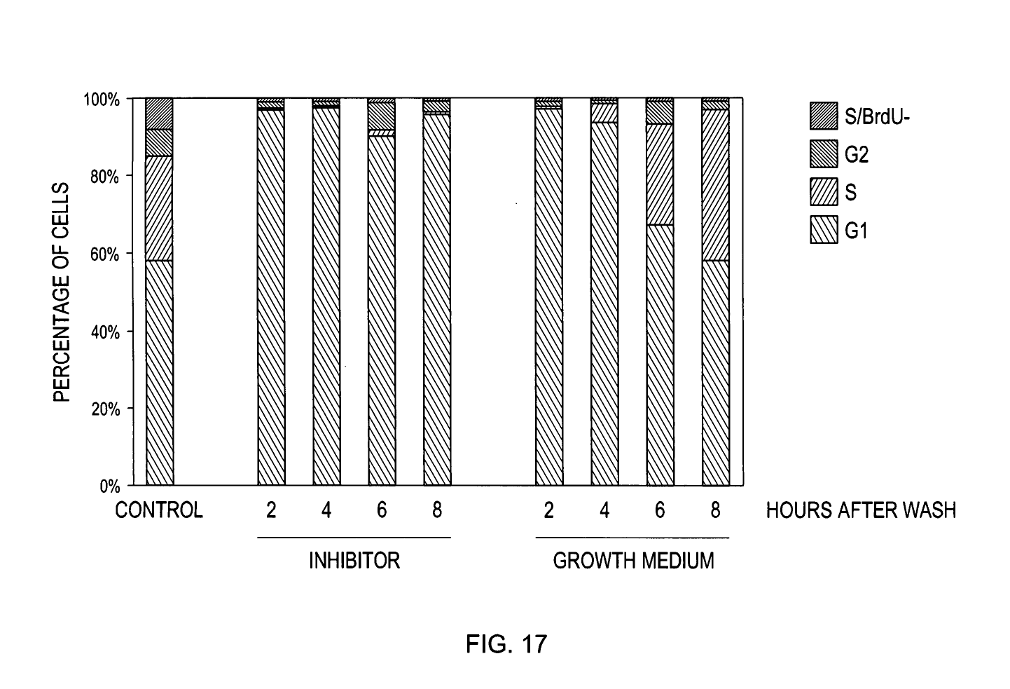

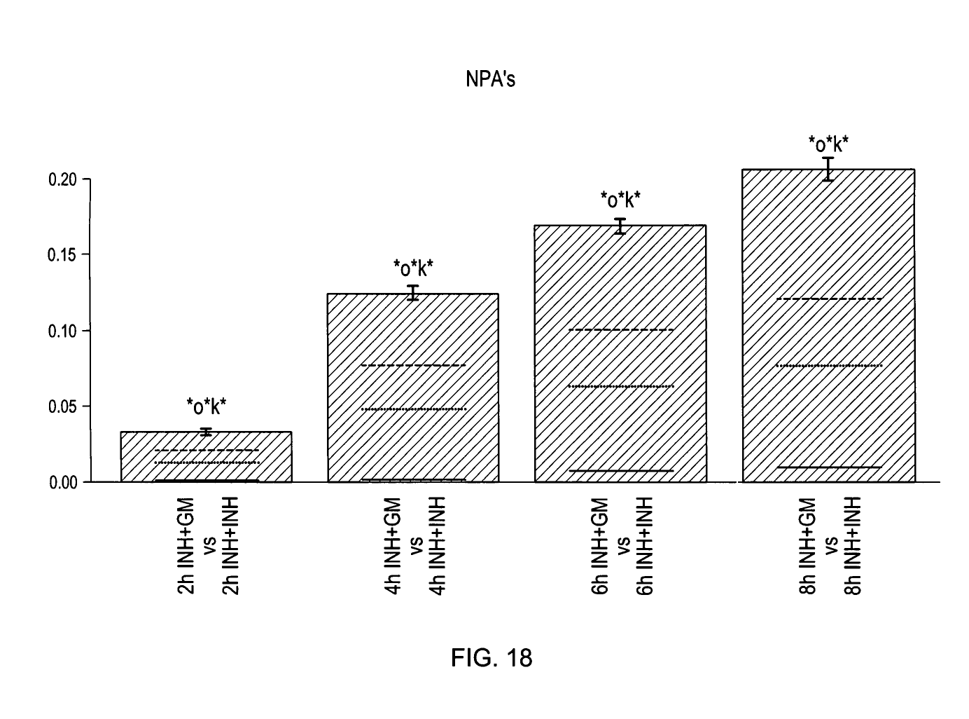

The NPA scores (FIG. 18) were found to increase over the range of time points from the 2-hour time point to the 8-hour time point which is consistent with the results of fluorescent activated cell sorting (FACS) analysis (FIG. 17) that show a corresponding increase in the number of cells in S-phase. The NPA scores were subjected to two permutation tests as described above at P-value<0.05, and the statistics (“O” and ‘K” statistics) both indicated that this particular biological system in the NHBE cells of the experiment, i.e., the cell cycle, was indeed perturbed. The analysis also identified leading nodes in the cell cycle network model which correspond exactly to the key mechanisms known to be involved in the entry of the S-phase: E2F proteins form a complex with RbP that is in turn phosphorylated by Cdk's under the (indirect) control of p53 and CHEK1. Also in conjunction with the Cdk's, G1/S-Cyclins are part of the leading nodes processes, as one would expect. The leading nodes identified by the method are: taof(TFDP1), taof(E2F2), CHEK1, TFDP1, kaof(CHEK1), taof(E2F3), taof(E2F1), taof(RB1), G1/S transition of mitotic cell cycle, CDC2, E2F2, CCNA2, CCNE1, THAP1, CDKN1A, TP53 P@S20, E2F3, kaof(CDK2). Taof is the abbreviation of “transcriptional activity of” and kaof is the abbreviation of “kinase activity of”. TP53 P@S20 is the abbreviation for serine at position 20 in TP53 is phosphorylated. The result shows that the combination of gene expression data and a mechanism-driven approach that leverages knowledge of a biological system embodied in a causal network model can be used to quantitate the perturbation of the biological system.

The invention is defined further in the following numbered paragraphs:

A computerized method for quantifying the perturbation of a biological system, comprising

receiving, at a first processor, a first set of treatment data corresponding to a response of a first set of biological entities to a first treatment, wherein a first biological system comprises biological entities including the first set of biological entities and a second set of biological entities, each biological entity in the first biological system interacting with at least one other of the biological entities in the first biological system;

receiving, at a second processor, a second set of treatment data corresponding to a response of the first set of biological entities to a second treatment different from the first treatment;

providing, at a third processor, a first computational causal network model that represents the first biological system and includes:
a first set of nodes representing the first set of biological entities,
a second set of nodes representing the second set of biological entities,
edges connecting nodes and representing relationships between the biological entities, and
direction values, representing the expected direction of change between the first treatment data and the second treatment data;

calculating, with a fourth processor, a first set of activity measures representing a difference between the first treatment data and the second treatment data for corresponding nodes in the first set of nodes;

generating, with a fifth processor, a second set of activity values for corresponding nodes in the second set of nodes, based on the first computational causal network model and the first set of activity measures.

The method of paragraph 137, further comprising:

generating, with a sixth processor, a score for the first computational causal network model representative of the perturbation of the first biological system to the first and second treatments based on the first computational causal network model and the second set of activity values.

The method of paragraph 137, wherein generating the second set of activity values comprises identifying, for each particular node in the second set of nodes, an activity value that minimizes a difference statement that represents the difference between the activity value of the particular node and the activity value or activity measure of nodes to which the particular node is connected with an edge within the first computational causal network model, wherein the difference statement depends on the activity values of each node in the second set of nodes.

The method of paragraph 139, wherein the difference statement further depends on the direction values of each node in the second set of nodes.

The method of paragraph 137, wherein each activity value in the second set of activity values is a linear combination of activity measures of the first set of activity measures.

The method of paragraph 141, wherein the linear combination depends on edges between nodes in the first set of nodes and nodes in the second set of nodes within the first computational causal network model, and also depends on edges between nodes in the second set of nodes within the first computational causal network model.

The method of paragraph 141, wherein the linear combination does not depend on edges between nodes in the first set of nodes within the first computational causal network model.

The method of 138, wherein the score has a quadratic dependence on the second set of activity values.

The method of paragraph 137, further comprising providing a variation estimate for each activity value of the second set of activity values by forming a linear combination of variation estimates for each activity measure of the first set of activity measures.

The method of paragraph 138, wherein a variation estimate for the score has a quadratic dependence on the second set of activity values.

The method of paragraph 138, further comprising:

representing the second set of activity values as a first activity value vector;

decomposing the first activity value vector into a first contributing vector and a first non-contributing vector, such that the sum of the first contributing and non-contributing vectors is the first activity value vector.

The method of paragraph 147, wherein the score does not depend on the first non-contributing vector.

The method of paragraph 148, wherein the score is calculated as a quadratic function of the second set of activity values, and the first non-contributing vector is in a kernel of quadratic function.

The method of paragraph 147, wherein the first non-contributing vector is in a kernel of a quadratic function based on a signed Laplacian associated with the first computational causal network model.

The method of paragraph 147, further comprising:

receiving, at the first processor, a third set of treatment data corresponding to a response of the first set of biological entities to a third treatment;

receiving, at the second processor, a fourth set of treatment data corresponding to a response of the first set of biological entities to a fourth treatment;

calculating, with the fourth processor, a third set of activity measures corresponding to the first set of nodes, each activity measure in the third set of activity measures representing a difference between the third set of treatment data and the fourth set of treatment data for a corresponding node in the first set of nodes;

generating, with the fifth processor, a fourth set of activity values, each activity value representing an activity value for a corresponding node in the second set of nodes based on the first computational causal network model and the third set of activity measures;

representing the fourth set of activity values as a second activity value vector;
decomposing the second activity value vector into a second contributing vector and a second non-contributing vector, such that the sum of the second contributing and non-contributing vectors is the second activity value vector; and
comparing the first and second contributing vectors.

The method of paragraph 151, wherein comparing the first and second contributing vectors comprises calculating a correlation between the first and second contributing vectors to indicate the comparability of the first and third sets of treatment data.

The method of paragraph 151, wherein comparing the first and second contributing vectors comprises projecting the first and second contributing vectors onto an image space of a signed Laplacian of a computational network model.

The method of paragraph 151, wherein the second set of treatment data contains the same information as the fourth set of treatment data.

The method of paragraph 137, further comprising:

receiving, at the first processor, a third set of treatment data corresponding to a response of a third set of biological entities to a third treatment different from the first treatment, wherein a second biological system comprises a plurality of biological entities including the third set of biological entities and a fourth set of biological entities, each biological entity in the second biological system interacting with at least one other of the biological entities in the second biological system;

receiving, at the second processor, a fourth set of treatment data corresponding to a response of the third set of biological entities to a fourth treatment different from the third treatment;

providing, at the third processor, a second computational causal network model that represents the second biological system and includes:
a third set of nodes representing the third set of biological entities,
a fourth set of nodes representing the fourth set of biological entities,
edges connecting nodes and representing relationships between the biological entities, and
direction values, representing the expected direction of change between the third treatment data and the fourth treatment data;

calculating, with the fourth processor, a third set of activity measures corresponding to the third set of nodes, each activity measure in the third set of activity measures representing a difference between the third set of treatment data and the fourth set of treatment data for a corresponding node in the third set of nodes;

generating, with the fifth processor, a fourth set of activity values, each activity value representing an activity value for a corresponding node in the fourth set of nodes, based on the second computational causal network model and the third set of activity measures; and

comparing the fourth set of activity values to the second set of activity values.

The method of paragraph 155, wherein comparing the fourth set of activity values to the second set of activity values comprises applying a kernel canonical correlation analysis based on a signed Laplacian associated with the first computational causal network model and a signed Laplacian associated with the second computational causal network model.

The computerized method of any of the above paragraphs 137-156, wherein the activity measure is a fold-change value, and the fold-change value for each node includes a logarithm of the difference between corresponding sets of treatment data for the biological entity represented by the respective node.

The computerized method of any of the above paragraphs 137-157, wherein the biological system includes at least one of a cell proliferation mechanism, a cellular stress mechanism, a cell inflammation mechanism, and a DNA repair mechanism.

The computerized method of any of the above paragraphs 137-158, wherein the first treatment includes at least one of exposure to aerosol generated by heating tobacco, exposure to aerosol generated by combusting tobacco, exposure to tobacco smoke, and exposure to cigarette smoke.

The computerized method of any of the above paragraphs 137-159, wherein the first treatment includes exposure to a heterogeneous substance, including a molecule or an entity that is not present in or derived from the biological system.

The computerized method of any of the above paragraphs 137-160, wherein the first treatment includes exposure to toxins, therapeutic compounds, stimulants, relaxants, natural products, manufactured products, and food substances.

The computerized method of any of paragraphs 155 and 156, wherein the first biological system and the second biological system are two different elements of the group consisting of an in vitro system, an in vivo system, a mouse system, a rat system, a non-human primate system and a human system.

The computerized method of paragraph 137, wherein:

the first treatment data corresponds to the first biological system exposed to an agent; and

the second treatment data corresponds to the first biological system not exposed to the agent.

The computerized method of paragraph 138, further comprises determining the statistical significance of the score which is indicative of the perturbation of the biological system.

The computerized method of paragraph 164, wherein the statistical significance of the score is determined by comparing the score against a plurality of test scores each computed from a plurality of randomly-generated test computational causal network models.

The computerized method of paragraph 165, wherein the randomly-generated test computational causal network models are generated by randomly assorting one or more aspects of the first computational causal network model.

The computerized method of paragraph 166, wherein the one or more aspects of the first computational causal network model include the labels of the first set of nodes, the edges connecting the second set of nodes to the first set of nodes, or the edges that connect the second set of nodes to each other.

1. A computerized method for quantifying perturbation of a biological system, comprising
receiving, at a first processor, a first set of treatment data corresponding to a response of a first set of biological entities to a first treatment, wherein a first biological system comprises biological entities including the first set of biological entities and a second set of biological entities, each biological entity in the first biological system interacting with at least one other of the biological entities in the first biological system;
receiving, at a second processor, a second set of treatment data corresponding to a response of the first set of biological entities to a second treatment different from the first treatment;
providing, at a third processor, a first computational causal network model that represents the first biological system and includes:
a first set of nodes representing the first set of biological entities,
a second set of nodes representing the second set of biological entities,
edges connecting nodes and representing relationships between the biological entities, and
direction values, representing an expected direction of change between the first treatment data and the second treatment data;
calculating, with a fourth processor, a first set of activity measures representing a difference between the first treatment data and the second treatment data for corresponding nodes in the first set of nodes;
generating, with a fifth processor, a second set of activity values for corresponding nodes in the second set of nodes, based on the first computational causal network model and the first set of activity measures.

2. The method of claim 1, further comprising:
generating, with a sixth processor, a score for the first computational causal network model representative of the perturbation of the first biological system to the first and second treatments based on the first computational causal network model and the second set of activity values.

3. The method of claim 1, wherein generating the second set of activity values comprises identifying, for each particular node in the second set of nodes, an activity value that minimizes a difference statement that represents the difference between the activity value of the particular node and the activity value or activity measure of nodes to which the particular node is connected with an edge within the first computational causal network model, wherein the difference statement depends on the activity values of each node in the second set of nodes.

4. The method of claim 1, wherein each activity value in the second set of activity values is a linear combination of activity measures of the first set of activity measures.

5. The method of claim 1, further comprising providing a variation estimate for each activity value of the second set of activity values by forming a linear combination of variation estimates for each activity measure of the first set of activity measures.

6. The method of claim 2, further comprising:
representing the second set of activity values as a first activity value vector;
decomposing the first activity value vector into a first contributing vector and a first non-contributing vector, such that the sum of the first contributing and non-contributing vectors is the first activity value vector.

7. The method of claim 6, wherein the first non-contributing vector is in a kernel of a quadratic function based on a signed Laplacian associated with the first computational causal network model.

8. The method of claim 6, further comprising:
receiving, at the first processor, a third set of treatment data corresponding to a response of the first set of biological entities to a third treatment;
receiving, at the second processor, a fourth set of treatment data corresponding to a response of the first set of biological entities to a fourth treatment;
calculating, with the fourth processor, a third set of activity measures corresponding to the first set of nodes, each activity measure in the third set of activity measures representing a difference between the third set of treatment data and the fourth set of treatment data for a corresponding node in the first set of nodes;
generating, with the fifth processor, a fourth set of activity values, each activity value representing an activity value for a corresponding node in the second set of nodes based on the first computational causal network model and the third set of activity measures;
representing the fourth set of activity values as a second activity value vector;
decomposing the second activity value vector into a second contributing vector and a second non-contributing vector, such that the sum of the second contributing and non-contributing vectors is the second activity value vector; and
comparing the first and second contributing vectors.

9. The method of claim 8, wherein comparing the first and second contributing vectors comprises calculating a correlation between the first and second contributing vectors to indicate the comparability of the first and third sets of treatment data.

10. The method of claim 8, wherein comparing the first and second contributing vectors comprises projecting the first and second contributing vectors onto an image space of a signed Laplacian of a computational network model.

11. The method of claim 1, further comprising:
receiving, at the first processor, a third set of treatment data corresponding to a response of a third set of biological entities to a third treatment different from the first treatment, wherein a second biological system comprises a plurality of biological entities including the third set of biological entities and a fourth set of biological entities, each biological entity in the second biological system interacting with at least one other of the biological entities in the second biological system;
receiving, at the second processor, a fourth set of treatment data corresponding to a response of the third set of biological entities to a fourth treatment different from the third treatment;
providing, at the third processor, a second computational causal network model that represents the second biological system and includes:
a third set of nodes representing the third set of biological entities,
a fourth set of nodes representing the fourth set of biological entities,
edges connecting nodes and representing relationships between the biological entities, and
direction values, representing the expected direction of change between the third treatment data and the fourth treatment data;
calculating, with the fourth processor, a third set of activity measures corresponding to the third set of nodes, each activity measure in the third set of activity measures representing a difference between the third set of treatment data and the fourth set of treatment data for a corresponding node in the third set of nodes;
generating, with the fifth processor, a fourth set of activity values, each activity value representing an activity value for a corresponding node in the fourth set of nodes, based on the second computational causal network model and the third set of activity measures; and
comparing the fourth set of activity values to the second set of activity values.

12. The method of claim 11, wherein comparing the fourth set of activity values to the second set of activity values comprises applying a kernel canonical correlation analysis based on a signed Laplacian associated with the first computational causal network model and a signed Laplacian associated with the second computational causal network model.

13. The computerized method of claim 1, wherein the activity measure is a fold-change value, and the fold-change value for each node includes a logarithm of the difference between corresponding sets of treatment data for the biological entity represented by the respective node.

14. The method of claim 11, wherein the first biological system and the second biological system are two different elements of the group consisting of an in vitro system, an in vivo system, a mouse system, a rat system, a non-human primate system and a human system.

15. The method of claim 1, wherein:
the first treatment data corresponds to the first biological system exposed to an agent; and
the second treatment data corresponds to the first biological system not exposed to the agent.

16. The method of claim 2, further comprises determining the statistical significance of the score which is indicative of the perturbation of the biological system.

17. The method of claim 16, wherein the statistical significance of the score is determined by comparing the score against a plurality of test scores each computed from a plurality of randomly-generated test computational causal network models.
